(19) United States
(12) Patent Application Publication
(10) Pub. No.: US 2018/0249023 A1
(43) Pub. Date: Aug. 30, 2018

(54) Information Processing Apparatus and Recording Medium

(71) Applicant: Konica Minolta, Inc., Tokyo (JP)

(72) Inventor: Hisataka Funakawa, Toyohashi-shi (JP)

(73) Assignee: Konica Minolta, Inc., Tokyo (JP)

(21) Appl. No.: 15/890,799

(22) Filed: Feb. 7, 2018

(30) Foreign Application Priority Data
Feb. 24, 2017 (JP) 2017-034053

(51) Int. Cl. H04N 1/00

(52) U.S. Cl. CPC H04N 1/00129; H04N 1/00411; H04N 1/00901; H04N 1/00904; H04N 1/00896

(57) ABSTRACT

An information processing apparatus includes a plurality of devices each having a power source, and a display. The display is shared by the plurality of devices and operated by receiving power supply from the power source of any one of the plurality of devices. The display determines a power supply device which is a device for supplying electric power to the display from the power source thereof, out of the plurality of devices, on the basis of a state of each of the plurality of devices.

The entire disclosure of Japanese Patent Application No. 2017-034053, filed on Feb. 24, 2017, is incorporated herein by reference in its entirety.

### BACKGROUND

### Technological Field

The present invention relates to an information processing apparatus and its relevant technique.

### Description of the Related Art

In a system constituted of a plurality of information processing apparatuses, there is a technique for allowing one display part (for example, a monitor) to be shared by the plurality of information processing apparatuses (see Japanese Patent Application Laid Open Gazette No. 2001-215942 (Patent Document 1)).

In the system disclosed in Patent Document 1, the plurality of information processing apparatuses are provided with respective dedicated power sources, and the display part (monitor) shared by the plurality of information processing apparatuses is also provided with a dedicated power source.

### SUMMARY

The present Applicant devises that in one information processing apparatus 110 (see FIG. 29) provided with a plurality of devices (for example, two devices 120 and 130), one display part 140 is shared by the plurality of devices 120 and 130. FIG. 29 is a diagram showing a general constitution of an information processing apparatus 100 in accordance with a comparative example. Also in such a case, as shown in FIG. 29, it can be thought that the two devices 120 and 130 are provided with respective dedicated power sources 121 and 131 and the display part 140 is also provided with a dedicated power source 141.

The dedicated power source 141 of the display part 140, however, allows of reducing the cost.

It is an object of the present invention to provide a technique for ensuring cost reduction in an information processing apparatus which includes a plurality of devices and a display shared by the plurality of devices.

The present invention is intended for an information processing apparatus. According to a first aspect of the present invention, the information processing apparatus includes a plurality of devices each having a power source, and a display which is shared by the plurality of devices and operated by receiving power supply from the power source of any one of the plurality of devices, and in the information processing apparatus of the present invention, the display has a hardware processor which determines a power supply device out of the plurality of devices, on the basis of a state of each of the plurality of devices, the power supply device being a device which supplies electric power to the display from the power source thereof.

The present invention is also intended for a non-transitory computer-readable recording medium. According to a second aspect of the present invention, the non-transitory computer-readable recording medium records therein a computer program to be executed by a computer provided in a display which is provided in an information processing apparatus including a plurality of devices each having a power source and is shared by the plurality of devices, to cause the computer to perform a) acquiring a state of each of the plurality of devices, and b) determining a power supply device which is a device that supplies electric power to the display from the power source thereof, out of the plurality of devices, on the basis of the state acquired in the operation a), the display being operated by receiving power supply from the power source of any one of the plurality of devices.

According to a third aspect of the present invention, the information processing apparatus includes a plurality of devices each having a power source, and a display which is shared by the plurality of devices and operated by receiving power supply from the power source of any one of the plurality of devices, and in the information processing apparatus of the present invention, the display has an electronic circuit which determines a power supply device out of the plurality of devices, on the basis of a state of each of the plurality of devices, the power supply device being a device which supplies electric power to the display from the power source thereof.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a view showing an appearance of an image forming apparatus (MFP);

FIG. 2 is a diagram showing a general constitution of an information processing apparatus;

FIG. 3 is a view showing function blocks of an image forming device;

FIG. 4 is a view showing function blocks of a server device;

FIG. 5 is a view showing a menu screen;

FIG. 6 is a view showing respective power supply states of the devices, and a power supply device and the like;

FIG. 7 is a conceptual diagram relating to determination of the power supply device in a case where both the devices are each in a power-on state;

FIG. 8 is a view showing respective power supply states of the devices, and the power supply device and the like in accordance with a second preferred embodiment;

FIG. 9 is a conceptual diagram relating to determination of the power supply device in a case where both the devices are each in the power-on state in accordance with the second preferred embodiment;

FIG. 10 is a view showing respective power supply states of the devices, and the power supply device and the like in accordance with a variation of the second preferred embodiment;

FIG. 11 is a view showing respective power supply states of the devices, and the power supply device and the like in accordance with a third preferred embodiment;

FIG. 12 is a conceptual diagram relating to determination of the power supply device in a case where both the devices are each in the power-on state in accordance with the third preferred embodiment;

FIG. 13 is a view showing respective power supply states of the devices, and the power supply device and the like in accordance with a first modification of the third preferred embodiment;

FIGS. 14 and 15 are views each showing respective power supply states of the devices, and the power supply device and the like in accordance with a second modification of the third preferred embodiment;

FIG. 16 is a view showing respective power supply states of the devices, and the power supply device and the like in accordance with a fourth preferred embodiment;

FIG. 17 is a conceptual diagram relating to determination of the power supply device in a case where both the devices are each in the power-on state in accordance with the fourth preferred embodiment;

FIG. 18 is a view showing respective electric power modes of the devices, and the power supply device and the like;

FIG. 19 is a conceptual diagram relating to determination of the power supply device in a case where both the devices are each in a power saving mode;

FIG. 20 is a diagram showing a general constitution of an information processing apparatus in accordance with a fifth preferred embodiment;

FIGS. 21 to 23 are control circuit diagrams each relating to determination control of the power supply device, and the like;

FIGS. 24 to 27 are control circuit diagrams each relating to determination control of the power supply device, and the like, in accordance with the fifth preferred embodiment;

FIG. 28 is a control circuit diagram relating to determination control of the power supply device, and the like, in accordance with a variation; and

FIG. 29 is a diagram showing a general constitution of an information processing apparatus in accordance with a comparative example.

### DETAILED DESCRIPTION OF EMBODIMENTS

Hereinafter, one or more embodiments of the present invention will be described with reference to the drawings. However, the scope of the invention is not limited to the disclosed embodiments.

### 1. The First Preferred Embodiment

### 1-1. General Constitution

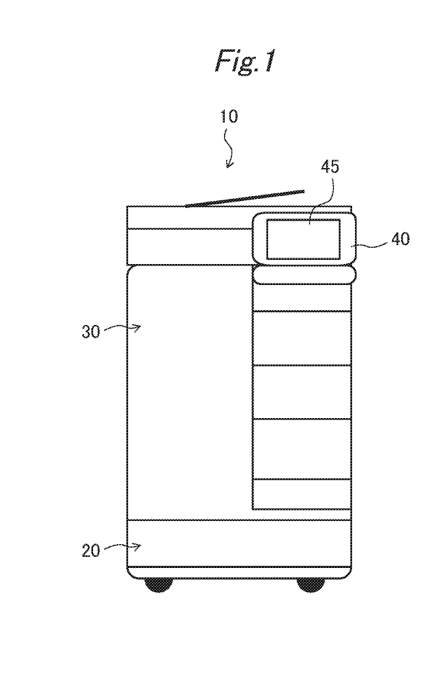

FIG. 1 is a view showing an appearance of an MFP (Multi-Functional Peripheral) 10. Herein, as an information processing apparatus, exemplarily shown is the MFP 10. The MFP 10 is also referred to as an image forming apparatus.

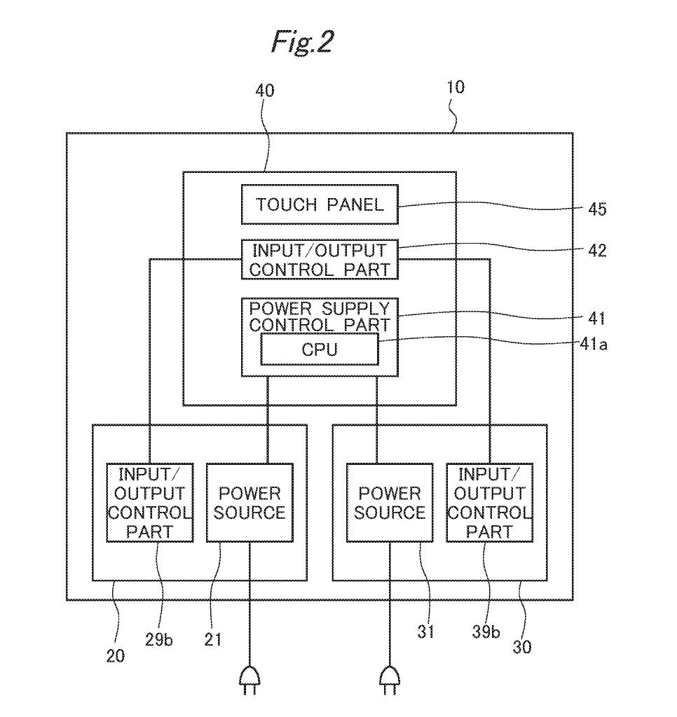

FIG. 2 is a diagram showing a general constitution of the information processing apparatus (MFP 10).

The MFP 10 comprises a plurality of devices (herein, two devices, i.e., a server device 20 and an image forming device 30) which operate independently of each other. Herein, the server device 20 and the image forming device 30 are accommodated in one package and formed as one unit. Further, it is assumed that the one package includes a predetermined member and a member provided on the predetermined member in an openable/closable manner (for example, an original document cover provided on a document platen of the MFP 10 rotatably with respect to a rotation axis of the document platen, or the like).

Furthermore, the MFP 10 also comprises an operation display part 40 (described later). As described later, the operation display part 40 is shared by the plurality of devices 20 and 30, as a display member of each of the plurality of devices 20 and 30.

### 1-2. Constitution of Image Forming Device 30

The image forming device 30 (also see FIG. 1) is a device which is capable of performing various jobs (a copy job, a scan job, and the like).

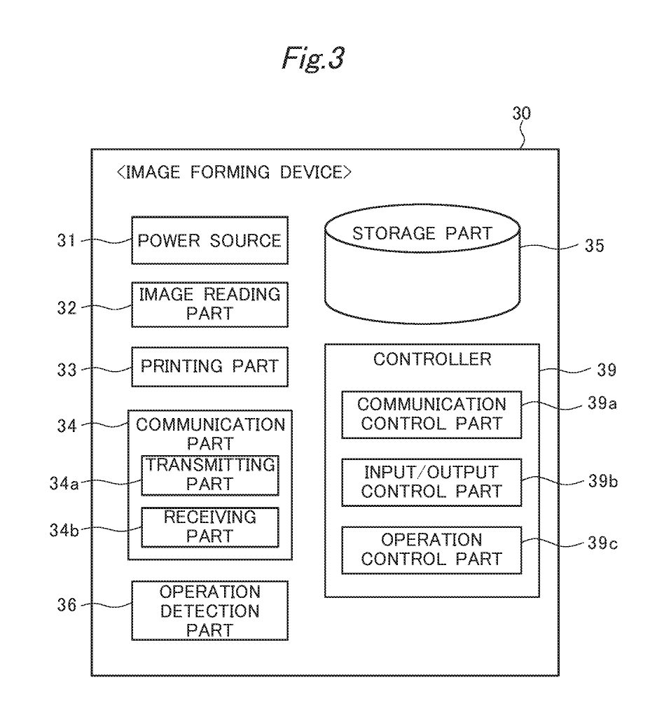

FIG. 3 is a view showing function blocks of the image forming device 30. The image forming device 30 controls management target functions (a copy function, a scanner function, a facsimile function, a box storage function, and the like). Specifically, as shown in FIG. 3, the image forming device 30 comprises an image reading part (image reader) 32, a printing part (printer) 33, a communication part 34, a storage part (storage) 35, an operation detection part 36, a power source 31, a controller (control part) 39, and the like, and multiply uses these constituent parts to implement various functions (management target functions).

The image reading part 32 is a processing part which optically reads (in other words, scans) an original manuscript placed on a predetermined position (ADF (Auto Document Feeder), a glass surface, or the like) of the image forming device 30 and generates image data of the original manuscript (also referred to as an “original manuscript image” or a “scan image”). The image reading part 32 is also referred to as a scanning part (scanner).

The image forming device 30 is a device capable of performing a job of reading the original manuscript placed on a predetermined position (also referred to as an image reading job), and also referred to as an image reading device.

The printing part 33 is an output part which prints out an image to various media such as paper on the basis of the data on an object to be printed. The image forming device 30 is a device capable of performing a job of printing out an image to various media (also referred to as a printing job), and also referred to as a printing device.

The communication part 34 is a processing part capable of performing facsimile communication via public networks or the like. Further, the communication part 34 is also capable of performing network communication via a network. The network communication uses various protocols such as TCP/IP (Transmission Control Protocol/Internet Protocol) and the like. By using the network communication, the image forming device 30 can transmit and receive various data to/from desired partners.

The storage part 35 is a storage unit such as a hard disk drive (HDD) or/and the like.

The operation detection part 36 is constituted of various sensors or the like, and is capable of detecting a user operation (for example, an operation of placing an original manuscript on the ADF) to a member (ADF or the like) included in the image forming device 30.

The power source 31 (also see FIG. 2) is a processing part which supplies electric power (power) to the processing parts in the image forming device 30. Further, the power source 31 is capable of supplying electric power not only to the processing parts in the image forming device 30 but also to the operation display part 40. When the image forming device 30 is in a power-off state, the power source 31 does not supply electric power (does not output (apply) a voltage) to the operation display part 40, but when the image forming device 30 is in a power-on state, the power source 31 supplies electric power (outputs (applies) a voltage) to the operation display part 40.

The controller 39 is a control unit for generally controlling the image forming device 30. The controller 39 is a computer system which is embedded in the image forming device 30 and comprises a CPU, various semiconductor memories (RAM and ROM), and the like. The controller 39 causes the CPU to execute a predetermined software program (hereinafter, also referred to simply as a program) stored in the ROM (for example, EEPROM (registered trademark)), to thereby implement various processing parts. Further, the program (in more detail, a group of program modules) may be recorded in one of various portable recording media (in other words, various non-transitory computer-readable recording media), such as a USB memory and the like, and read out from the recording medium to be installed in the image forming device 30. Alternatively, the program may be downloaded via a network to be installed in the image forming device 30.

Specifically, as shown in FIG. 3, the controller 39 executes the above-described program, to thereby implement various processing parts including a communication control part (communication controller) 39a, an input/output control part (input/output controller) 39b, and an operation control part (operation controller) 39c.

The communication control part 39a is a processing part for controlling a communication operation with other apparatus(es) and other device(s) in the self-apparatus 10 in cooperation with the communication part 34 and the like.

The input/output control part 39b is a processing part for controlling an input operation to the operation display part 40 (a touch panel 45) and controlling a display operation on the operation display part 40 (the touch panel 45) in cooperation (coordination) with the operation display part 40 (FIG. 1). For example, the input/output control part 39b displays information relating to the management target functions of the image forming device 30, and the like, on the operation display part 40 (the touch panel 45) and acquires operation input information relating to the user operation to the operation display part 40, from the operation display part 40.

The operation control part 39c is a processing part for controlling an operation (a switching operation of supply destinations of electric power, or the like) of the image forming device 30.

### 1-3. Constitution of Server Device 20

The server device 20 (also see FIG. 1) is a device which is capable of performing a server function. The server device 20 is for example, a general-purpose computer apparatus.

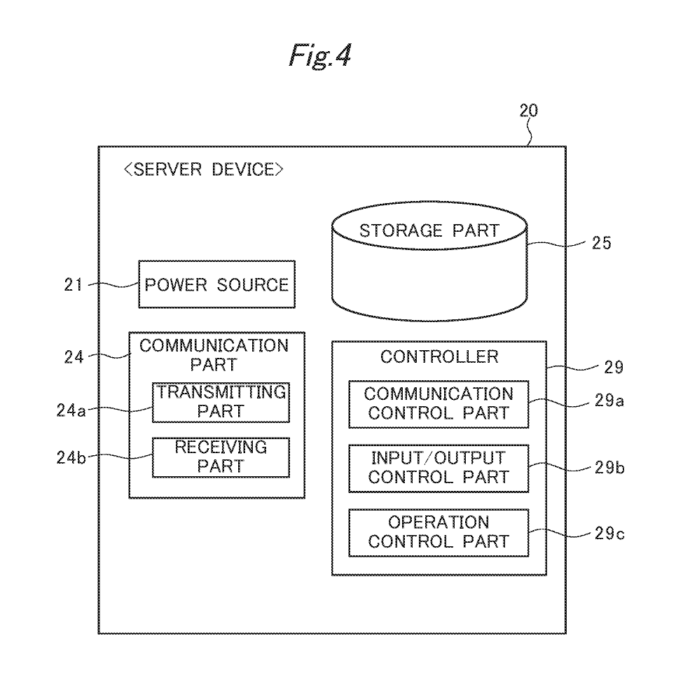

FIG. 4 is a view showing function blocks of the server device 20.

As shown in the functional block diagram of FIG. 4, the server device 20 comprises a communication part 24, a storage part (storage) 25, a power source 21, a controller (control part) 29, and the like, and multiply uses these constituent parts to implement various functions.

The communication part 24 is a processing part capable of performing network communication. The network communication uses various protocols such as TCP/IP (Transmission Control Protocol/Internet Protocol) and the like. By using the network communication, the server device 20 can transmit and receive various data in coordination with desired partners.

The storage part 25 is a storage unit such as a nonvolatile semiconductor memory or/and the like.

The power source 21 (also see FIG. 2) is a processing part which supplies electric power (power) to the processing parts in the server device 20. Further, the power source 21 is capable of supplying electric power not only to the processing parts in the server device 20 but also to the operation display part 40. When the server device 20 is in the power-off state, the power source 21 does not supply electric power (does not output (apply) a voltage) to the operation display part 40, but when the server device 20 is in the power-on state, the power source 21 supplies electric power (outputs (applies) a voltage) to the operation display part 40.

The controller (control part) 29 is a control unit for generally controlling the server device 20. The controller 29 is a computer system which is embedded in the server device 20 and comprises a CPU, various semiconductor memories (RAM and ROM), and the like. The controller 29 causes the CPU to execute a predetermined program stored in a memory part (such as a semiconductor memory or the like), to thereby implement various processing parts. Further, the program (in more detail, a group of program modules) may be recorded in one of various portable recording media (in other words, various non-transitory computer-readable recording media), such as a USB memory and the like, and read out from the recording medium to be installed in the server device 20. Alternatively, the program may be downloaded via a network to be installed in the server device 20.

Specifically, the controller 29 executes the program or the like, to thereby implement various processing parts including a communication control part (communication controller) 29a, an input/output control part (input/output controller) 29b, and an operation control part (operation controller) 29c.

The communication control part 29a is a processing part for controlling a communication operation with other apparatus(es) and other device(s) in the self-apparatus 10 in cooperation with the communication part 24 and the like.

The input/output control part 29b is a processing part for controlling an input operation to the operation display part 40 (the touch panel 45) and controlling a display operation on the operation display part 40 (the touch panel 45) in cooperation (coordination) with the operation display part 40. For example, the input/output control part 29b displays information relating to management target functions of the server device 20, and the like, on the operation display part 40 (the touch panel 45) and acquires operation input information relating to the user operation to the operation display part 40, from the operation display part 40.

The operation control part 29c is a processing part for controlling an operation (a switching operation of supply destinations of electric power, or the like) of the server device 20.

Further, the server device 20 controls management target functions (an E-mail function, a data storage function, a format conversion function, an image edit function, and the like). Specifically, applications (application software programs) used for implementing various functions (management target functions) are installed in the server device 20 in advance, and the server device 20 implements various functions (management target functions) by using the respective applications.

Herein, in the server device 20, installed in advance are an E-mail application, a data storage application, a format conversion application, an image edit application, and the like.

The E-mail application is an application for performing transmission and reception of E-mails between the server device 20 and other apparatuses, and the server device 20 executes the E-mail application, to thereby implement the E-mail function. The data storage application is an application for storing various data into the server device 20, and the server device 20 executes the data storage application, to thereby implement the data storage function. The format conversion application is an application for converting a file format of a specified file into another file format, and the server device 20 executes the format conversion application, to thereby implement the format conversion function. The image edit application is an application for editing specified image data, and the server device 20 executes the image edit application, to thereby implement the image edit function.

### 1-4. Constitution of Operation Display Part 40

The MFP 10 is provided with the substantially plate-like operation display part 40 (see FIG. 1). The operation display part 40 has the touch panel 45 (see FIG. 1) on a front surface side thereof The touch panel 45 is a liquid crystal display panel in which various sensors or the like are embedded, and capable of displaying various information thereon and receiving various operation inputs from an operating user (manipulating user). The touch panel 45 serves as an operation input part for receiving the operation inputs to the touch panel 45 and also serves as a display panel for displaying various information.

As shown in FIG. 2, the operation display part 40 has a power supply control part 41, an input/output control part 42, and the like.

The power supply control part 41 is a processing part for determining one device (power supply device) for supplying electric power to the operation display part 40 from the power source thereof, out of the plurality of devices (herein, the server device 20 and the image forming device 30). Herein, the power supply control part 41 is a computer system which is embedded in the operation display part 40 and comprises a CPU 41a, various semiconductor memories (RAM and ROM), and the like, and causes the CPU 41a to execute a predetermined program stored in a memory part (not shown), to thereby implement its functions. The power supply control part 41 performs a determination process (determination control) of the power supply device, and the like. Further, the program (in more detail, a group of program modules) may be recorded in one of various portable recording media such as a USB memory and the like, and read out from the recording medium to be installed in the operation display part 40. Alternatively, the program may be downloaded via a network to be installed in the operation display part 40.

Further, it can be thought that the operation display part 40 is supplied with electric power from both the server device 20 and the image forming device 30. In this case, however, when an output voltage of the power source 21 in the server device 20 is different from that of the power source 31 in the image forming device 30, an electric current sometimes flows from the device having higher output voltage to the device having lower output voltage (in other words, flows back). For this reason, it is preferable that a single device should supply electric power to the operation display part 40. In consideration of such circumstances or the like, the operation display part 40 determines one of the server device 20 and the image forming device 30 as the power supply device.

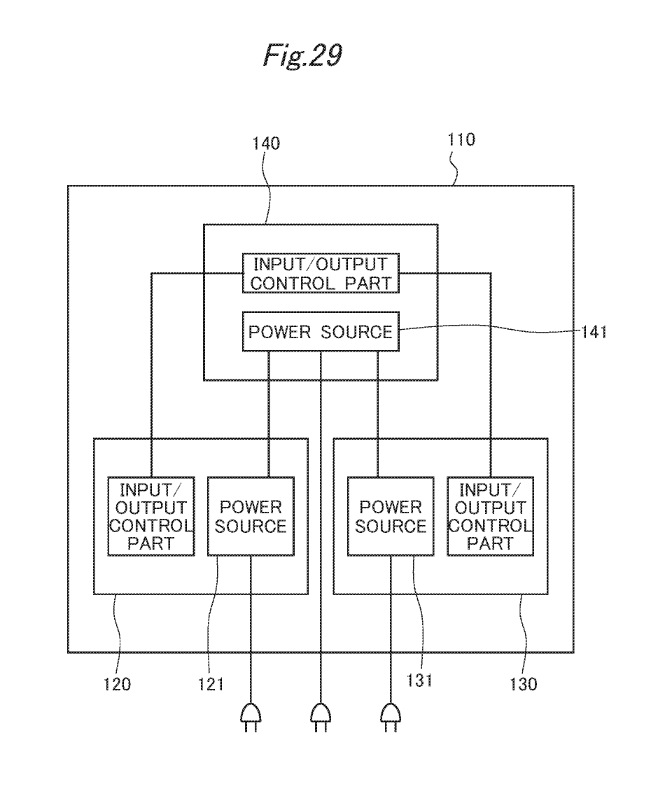

Specifically, the operation display part 40 does not have a dedicated (original) power source (also see FIG. 29), but is operated by receiving power supply (supply of electric power) from the power source 21 or 31 of either one of the server device 20 and the image forming device 30. In more detail, the power supply control part 41 determines either one of the server device 20 and the image forming device 30, as the power supply device, on the basis of respective states of the devices (herein, respective power supply states (power-on/off states) of the devices). Then, the operation display part 40 is operated by receiving the power supply from the power source of the device which is determined as the power supply device.

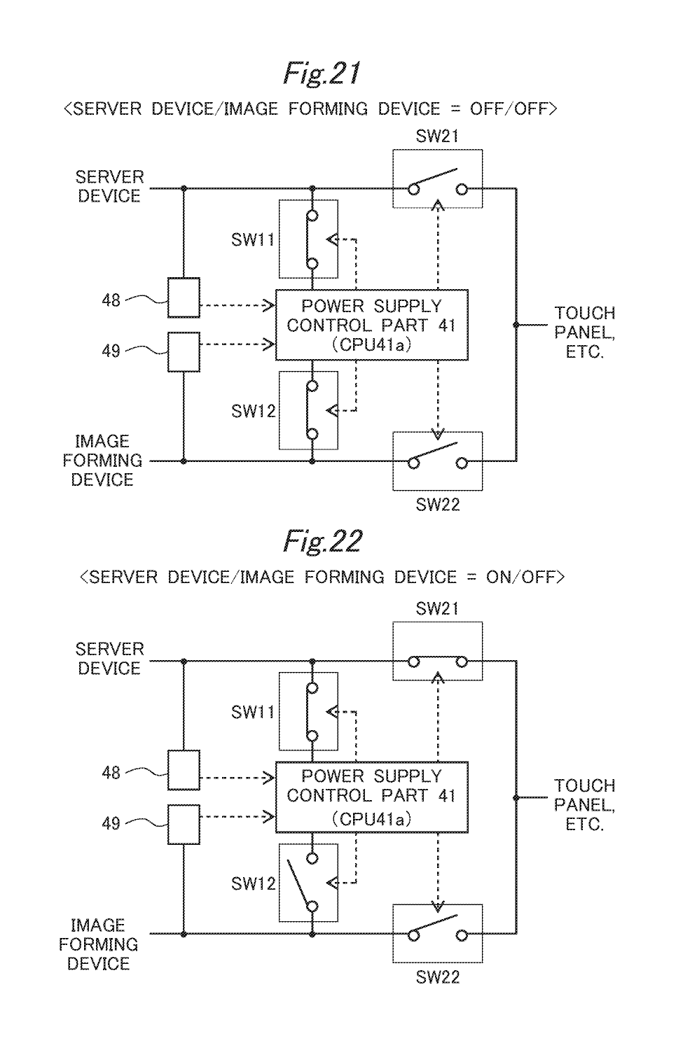

FIGS. 21 to 23 are control circuit diagrams each relating to the determination process (determination control) of the power supply device, and the like, in the operation display part 40 (the power supply control part 41). The power supply control part 41 (the CPU 41a) has four changeover switches SW11, SW12, SW21, and SW22, and controls respective operations of the changeover switches by sending signals (switching signals) to the changeover switches. In each of the control circuit diagrams, a power supply line is represented by a thick line and a signal line is represented by a dotted line.

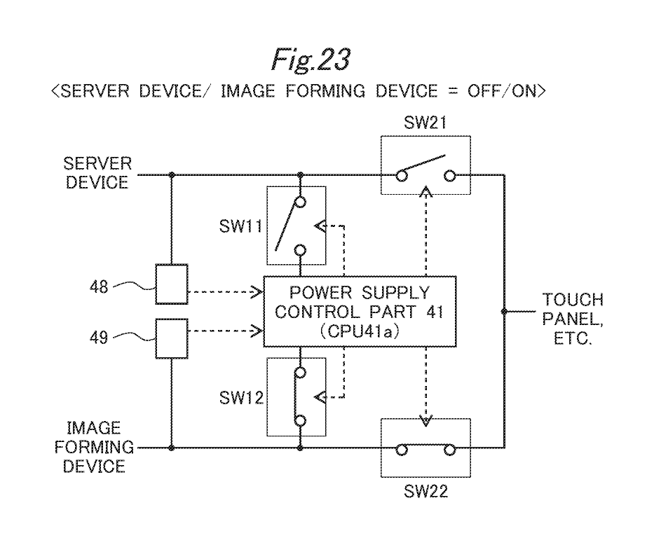

The changeover switch SW11 is a switching part for switching between ON/OFF (open state/closed state) of an input circuit for supplying the output voltage from the power source 21 of the server device 20 to the power supply control part 41 (the CPU 41a). When the changeover switch SW11 is in the closed state (see FIG. 22), the output voltage from the power source 21 of the server device 20 is supplied to the power supply control part 41. Conversely, when the changeover switch SW11 is in the open state (see FIG. 23), the output voltage from the power source 21 of the server device 20 is not supplied to the power supply control part 41.

The changeover switch SW21 is a switching part for switching between ON/OFF (open state/closed state) of an input circuit for supplying the output voltage from the power source 21 of the server device 20 to the touch panel 45 and the like of the operation display part 40. When the changeover switch SW21 is in the closed state (see FIG. 22), the output voltage from the power source 21 of the server device 20 is supplied to the touch panel 45 and the like. Conversely, when the changeover switch SW21 is in the open state (see FIG. 23), the output voltage from the power source 21 of the server device 20 is not supplied to the touch panel 45 and the like.

The changeover switch SW12 is a switching part for switching between ON/OFF (open state/closed state) of an input circuit for supplying the output voltage from the power source 31 of the image forming device 30 to the power supply control part 41 (the CPU 41a). When the changeover switch SW12 is in the closed state (see FIG. 23), the output voltage from the power source 31 of the image forming device 30 is supplied to the power supply control part 41. Conversely, when the changeover switch SW12 is in the open state (see FIG. 22), the output voltage from the power source 31 of the image forming device 30 is not supplied to the power supply control part 41.

The changeover switch SW22 is a switching part for switching between ON/OFF (open state/closed state) of an input circuit for supplying the output voltage from the power source 31 of the image forming device 30 to the touch panel 45 and the like of the operation display part 40. When the changeover switch SW22 is in the closed state (see FIG. 23), the output voltage from the power source 31 of the image forming device 30 is supplied to the touch panel 45 and the like. Conversely, when the changeover switch SW22 is in the open state (see FIG. 22), the output voltage from the power source 31 of the image forming device 30 is not supplied to the touch panel 45 and the like.

Further, in an initial state (non-conducting state) of the power supply control part 41 (the CPU 41a), the changeover switches SW11 and SW12 are each in the closed state and the changeover switches SW21 and SW22 are each in the open state (see FIG. 21).

The input/output control part 42 is a processing part for controlling an operation inputting operation or the like of the user to the operation display part 40 (the touch panel 45 and the like) and controlling a display operation on the operation display part 40 (the touch panel 45 and the like).

This operation display part 40 (the touch panel 45 and the like) is shared by the two devices, i.e., the server device 20 and the image forming device 30.

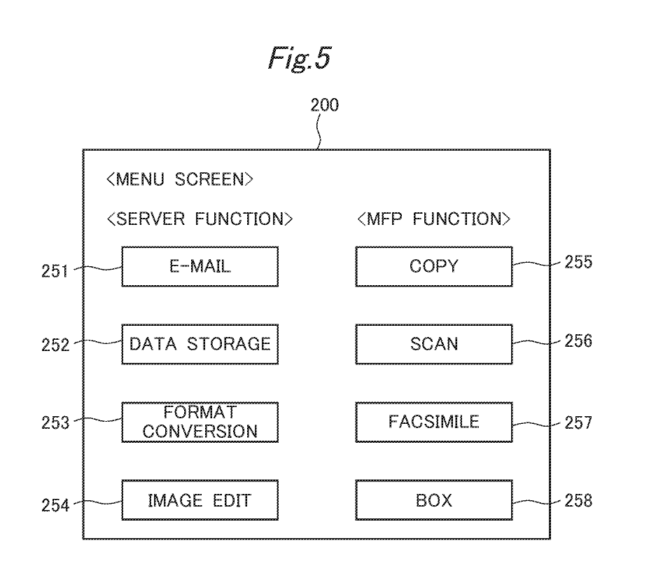

Specifically, the operation display part 40 displays a menu screen 200 (see FIG. 5) on the touch panel 45. In the menu screen 200, displayed are buttons 251 to 254 corresponding to the management target functions of the server device 20 and buttons 255 to 258 corresponding to the management target functions of the image forming device 30. Then, the user selects (presses) a button corresponding to a desired function among the plurality of buttons 251 to 258 corresponding to the plurality of functions.

In response to a selecting operation of the user, the operation display part 40 (the input/output control part 42) cooperates with the management device of the function corresponding to the button selected by the user, to perform a display processing relating to the function on the touch panel 45. In other words, a display processing relating to the device which is alternatively selected out of the plurality of devices 20 and 30 is performed on the touch panel 45.

In the menu screen 200 (FIG. 5), for example, when the button 251 corresponding to the E-mail function (the management target function of the server device 20) is selected, the operation display part 40 (the input/output control part 42) transmits and receives display image data to/from the server device 20 and displays a top screen (not shown) of the E-mail application and the like on the touch panel 45.

Further, in the menu screen 200, for example, when the button 255 corresponding to the copy function (the management target function of the image forming device 30) is selected (pressed), the operation display part 40 (the input/output control part 42) transmits and receives display image data to/from the image forming device 30 and displays a setting screen (not shown) of the copy function (copy job) and the like on the touch panel 45.

Furthermore, the devices 20 and 30 each have screen data of the menu screen 200, and when the power of either one of the devices 20 and 30 is changed to an ON state, the menu screen 200 is displayed on the touch panel 45 in accordance with display output of the device which is changed to the power-on state.

Thus, the operation display part 40 is a display member (operation member) for performing a display processing relating to the server device 20 and also a display member (operation member) for performing a display processing relating to the image forming device 30.

Further, the operation display part 40 also has voltage detection parts 48 and 49 (see FIG. 21 and the like).

The voltage detection part 48 (voltage detection circuit) is a processing part which is capable of detecting (measuring) an output voltage (voltage applied to the operation display part 40) from the power source 21 of the server device 20 and notifying the power supply control part 41 of a detection value (measured value) of the output voltage.

The voltage detection part 49 (voltage detection circuit) is a processing part which is capable of detecting (measuring) an output voltage (voltage applied to the operation display part 40) from the power source 31 of the image forming device 30 and notifying the power supply control part 41 of a detection value (measured value) of the output voltage.

### 1-5. Operation

In this preferred embodiment, the operation display part 40 (power supply control part 41) determines the power supply device on the basis of a state of each of the server device 20 and the image forming device 30.

Specifically, the power supply control part 41 determines the power supply device on the basis of whether each of the server device 20 and the image forming device 30 is in the power-on state or the power-off state. Then, the operation display part 40 is operated by receiving the power supply (supply of electric power) from the power source of the device which is determined as the power supply device.

Specifically, when one of the server device 20 and the image forming device 30 is in the power-on state, the device which is in the power-on state is determined as the power supply device.

Further, when both the server device 20 and the image forming device 30 are each in the power-on state, one device which is determined in advance (herein, the server device 20) is determined as the power supply device.

Then, the operation display part 40 is operated by receiving the power supply from the power source of the device which is determined as the power supply device. Further, when both the server device 20 and the image forming device 30 are each in the power-off state, no power supply is performed to the operation display part 40 and the operation display part 40 is not operated, as described later.

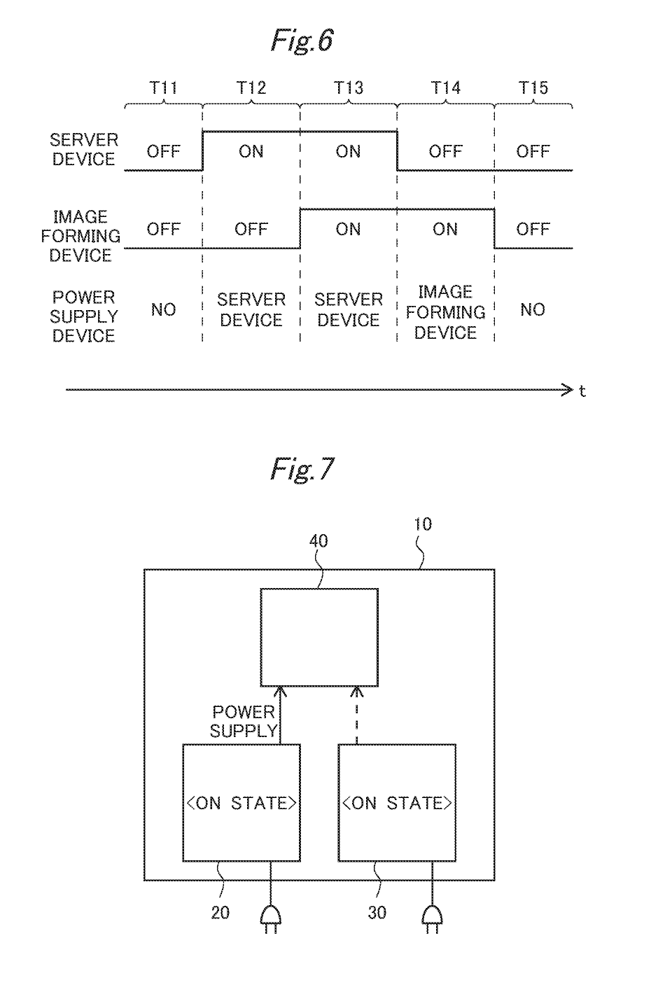

As to the determination process (determination control) of the power supply device and the like, description will be made below with reference to FIGS. 6, 21 to 23 and the like.

FIG. 6 is a view showing respective power supply states (power-on/off states) of the devices 20 and 30, and the power supply device and the like.

First, in a period T11 of FIG. 6, both the server device 20 and the image forming device 30 are each in the power-off state (non-conducting state). As described above, the respective power sources 21 and 31 of the devices 20 and 30 do not apply a voltage to the operation display part 40 when the respective self-devices are each in the power-off state. As a result, the operation display part 40 is in the non-conducting state (the operation display part 40 is not operated).

After that, when a power supply switch of the server device 20 is turned on, to thereby bring the server device 20 into the power-on state (conducting state) from the power-off state (non-conducting state) (see a period T12), as described below, the operation display part 40 is operated (starts an operation) by receiving the power supply from the power source 21 of the server device 20.

Specifically, when the power of the server device 20 is changed to the ON state, the power source 21 of the server device 20 applies a voltage (e.g., 5.0 V (volt)) not lower than a predetermined value (e.g., 4.5 V) to the operation display part 40. The voltage is thereby supplied from the power source 21 of the server device 20 to the operation display part 40 (in detail, the power supply control part 41) (also see FIG. 21), and the power supply control part 41 (the CPU 41a) starts an operation.

When the operation of the power supply control part 41 (the CPU 41a) is started, the power supply control part 41 acquires the respective output voltages from the power sources 21 and 31 of the devices 20 and 30 by using the voltage detection parts 48 and 49, respectively. Specifically, the voltage detection part 48 measures (detects) the output voltage (5.0 V) of the power source 21 of the server device 20 and notifies the power supply control part 41 of the measured value (5.0 V) of the output voltage from the power source 21. Then, the power supply control part 41 determines, on the basis that the output voltage acquired from the voltage detection part 48 (the output voltage from the power source 21 of the server device 20) is not lower than the predetermined value, that the server device 20 is in the power-on state. Further, since the image forming device 30 is in the power-off state at this point in time, the voltage detection part 49 does not detect any output voltage of the power source 31 of the image forming device 30 (the measured value of the output voltage is “0”). Furthermore, when the operation of the power supply control part 41 is started, the power supply control part 41 monitors the output voltages from the power sources 21 and 31 of the devices 20 and 30 by using the voltage detection parts 48 and 49, respectively. In other words, the operation display part 40 monitors the respective power supply states of the devices 20 and 30.

Then, on the basis of the respective power supply states of the devices 20 and 30, the power supply control part 41 determines the device which is in the power-on state (herein, the server device 20) as the power supply device. For example, in a case where there are a device which is in the power-on state and another device which is in the power-off state among the plurality of devices, the power supply control part 41 determines the device which is in the power-on state (herein, the server device 20), as the power supply device.

After the power supply device is determined, the power supply control part 41 controls the changeover switches so that a voltage should be supplied from the power source (21) of the device (herein, the server device 20) determined as the power supply device to the operation display part 40 (the touch panel 45 and the like).

Specifically, the power supply control part 41 sends the switching signal to the changeover switch SW12, to thereby control the changeover switch SW12 to be brought into the open state, and also sends the switching signal to the changeover switch SW21, to thereby control the changeover switch SW21 to be brought into the closed state (see FIG. 22). In other words, the power supply control part 41 controls the supply of electric power to the operation display part 40 so that the output voltage from the power source 31 of the image forming device 30 should not be supplied to the operation display part 40 (the power supply control part 41, and the touch panel 45 and the like) and the output voltage from the power source 21 of the server device 20 should be supplied to the operation display part 40 (the power supply control part 41, and the touch panel 45 and the like).

The operation display part 40 thereby starts its operation by receiving the power supply (supply of electric power) from the power source 21 of the server device 20, and displays the menu screen 200 (FIG. 5) or the like on the touch panel 45 in accordance with the display output of the server device 20.

Further, in the initial state (see FIG. 21), if the server device 20 and the image forming device 30 are changed to the power-on state at the same time, the respective voltages of the power sources 21 and 31 of the devices 20 and 30 are supplied (inputted) to the power supply control part 41. In this case, the power supply control part 41 momentarily permits the supply of voltages from both the power sources 21 and 31. Then, after the power supply control part 41 starts its operation by receiving the supply of voltages from both the power sources, the power supply control part 41 determines either one of the devices as the power supply device. After that, the power supply control part 41 controls the changeover switches so that the output voltage from the power source of the device which is not determined as the power supply device should not be supplied to the operation display part and the output voltage from the power source of the device which is determined as the power supply device should be supplied to the operation display part.

After that (after the period T12), when the power of the image forming device 30 is also changed from the OFF state (non-conducting state) to the ON state (conducting state) (a period T13 of FIG. 6), the operation display part 40 (the power supply control part 41) determines the device (herein, the server device 20) which is determined in advance out of the devices 20 and 30, as the power supply device. Specifically, in a case where at least two devices among the plurality of devices are each in the power-on state, when the server device 20 is in the power-on state, the power supply control part 41 determines the server device 20 as the power supply device. In other words, when the server device 20 is in the power-on state, the server device 20 is determined as the power supply device, regardless of the power supply state of the image forming device 30. Further, it is assumed that which device should be determined as the power supply device in the case where both the devices 20 and 30 are each in the power-on state is fixedly determined.

After the power supply device is determined, the power supply control part 41 controls the respective operations of the changeover switches. Specifically, the power supply control part 41 controls the changeover switches so that (only) the output voltage from the power source 21 of the server device 20 should be supplied to the whole operation display part 40 (see FIG. 22), and the operation display part 40 continues the operation by receiving the power supply from the power source 21 of the server device 20 (also see FIG. 7). Further, FIG. 7 is a conceptual diagram relating to determination of the power supply device in the case where both the devices 20 and 30 are each in the power-on state.

After that, for example, when the power of the server device 20 is changed from the ON state to the OFF state (a period T14 of FIG. 6), the operation display part 40 is operated (continues the operation) by receiving the power supply from the power source 31 of the other device (the image forming device 30) which is in the power-on state.

Specifically, when the power of the server device 20 is changed from the ON state (conducting state) to the OFF state (non-conducting state), the supply of voltage from the server device 20 to the operation display part 40 is stopped.

In more detail, as described above, the operation display part 40 (the power supply control part 41) monitors the respective output voltages of the power sources 21 and 31 of the devices 20 and 30 by using the voltage detection parts 48 and 49, respectively. Then, when the output voltage of the device (herein, the server device 20) which is determined as the power supply device is reduced to be not higher than the predetermined value (e.g., 4.5V), the power supply control part 41 determines (detects) that the power of the power supply device is changed from the ON state to the OFF state. Further, herein, at the point in time when it is detected that the server device 20 is changed to the power-off state, the output voltage of the power source 31 of the image forming device 30 is 4.8 V without being changed.

Then, on the basis of the respective power supply states of the devices 20 and 30, the power supply control part 41 determines one device (herein, the image forming device 30) which is in the power-on state, as the power supply device (switches the power supply device from the server device 20 to the image forming device 30). In detail, the power supply control part 41 controls the changeover switches SW12 and SW22 to be each in the closed state, and controls the changeover switches SW11 and SW21 to be each in the open state (see FIG. 23). The output voltage of the power source 31 of the image forming device 30 is thereby supplied to the whole operation display part 40 (the power supply control part 41, and the touch panel 45 and the like), and the operation display part 40 continues its operation by receiving the power supply from the power source 31 of the image forming device 30.

Further after that, when the power of the image forming device 30 is also changed from the ON state to the OFF state (a period T15 of FIG. 6), the supply of voltage from the image forming device 30 to the operation display part 40 is stopped. Then, since no voltage is supplied to the operation display part 40 from the power source of any device, the operation display part 40 is changed from the conducting state to the non-conducting state, and the operation of the operation display part 40 is stopped. Furthermore, the power supply control part 41 returns each of the changeover switches to the initial state (FIG. 21) and then stops its operation.

Thus, in the first preferred embodiment, the operation display part 40 shared by the plurality of devices (herein, the two devices, i.e., the server device 20 and the image forming device 30) is operated by receiving the power supply from the power source of any one of the plurality of devices 20 and 30. For this reason, it is not necessary to provide a dedicated power source in the operation display part 40 (also see FIG. 29). Therefore, it is possible to reduce the cost in the MFP 10 which comprises the plurality of devices 20 and 30 and the operation display part 40 shared by the plurality of devices 20 and 30.

Further, out of the plurality of devices, the device (power supply device) for supplying electric power to the operation display part 40 from the power source thereof is determined on the basis of the respective states of the plurality of devices (whether each of the plurality of devices is in the power-on state or the power-off state). In other words, on the basis of whether each of the devices can supply the electric power (voltage) to the operation display part 40, the power supply device is determined. Then, one device which is in the power-on state (one device which can supply the electric power (voltage) to the operation display part 40) is determined as the power supply device, and the operation display part 40 is operated by the power supply from the one device. Therefore, even in the case where no dedicated power source is provided in the operation display part 40, it is possible to appropriately cause the operation display part 40 to operate on the basis of the respective states (power supply states) of the devices.

Further, in the first preferred embodiment, in the case where both the server device 20 and the image forming device 30 are each in the power-on state, the device (herein, the server device 20) which is determined in advance is determined as the power supply device, but this is only one exemplary case. For example, in the case where both the server device 20 and the image forming device 30 are each in the power-on state, the power supply device may be determined on the basis of respective priorities of the devices which are determined in advance.

Specifically, mutual priorities of the server device 20 and the image forming device 30 are determined in advance by an administrator or the like by using a predetermined parameter or the like. For example, in a case where the administrator knows that the performance of the power source 21 of the server device 20 is higher than that of the power source 31 of the image forming device 30, the administrator sets the respective priorities so that the server device 20 should have a priority higher than that of the image forming device 30.

Then, when both the server device 20 and the image forming device 30 are each in the power-on state, the power supply control part 41 determines the device (also referred to as a priority device) which has the highest priority among the devices 20 and 30, on the basis of the priorities determined in advance. After that, the power supply control part 41 determines the device which is determined as the priority device, as the power supply device.

For example, in the case where both the server device 20 and the image forming device 30 are each in the power-on state, when the server device 20 has a priority higher than that of the image forming device 30, the server device 20 is determined as the priority device. Then, the server device 20 which is determined as the priority device is determined as the power supply device.

Conversely, in the case where both the server device 20 and the image forming device 30 are each in the power-on state, when the image forming device 30 has a priority higher than that of the server device 20, the image forming device 30 is determined as the priority device. Then, the image forming device 30 which is determined as the priority device is determined as the power supply device.

Thus, in the case where both the server device 20 and the image forming device 30 are each in the power-on state, the power supply device is determined on the basis of the priorities determined in advance.

### 2. The Second Preferred Embodiment

The second preferred embodiment is a variation of the first preferred embodiment. Hereinafter, discussion will be made, centering on the difference between the first and second preferred embodiments.

In the above-described first preferred embodiment, in the case where both the server device 20 and the image forming device 30 are each in the power-on state, the device which is determined in advance is determined as the power supply device.

On the other hand, in the second to fourth preferred embodiments described later, the power supply device is determined by using methods which are different from that of the above-described first preferred embodiment.

In the second preferred embodiment, in the case where both the server device 20 and the image forming device 30 are each in the power-on state, the power supply device is determined on the basis of the respective output voltages of the power sources 21 and 31 of these devices 20 and 30.

Specifically, the operation display part 40 (the power supply control part 41) acquires the respective output voltages of the power sources 21 and 31 of these devices 20 and 30 immediately after the power supply state of one device among the devices 20 and 30 is changed. Then, the power supply control part 41 determines the device whose power source has the highest output voltage, out of the devices 20 and 30, as the power supply device.

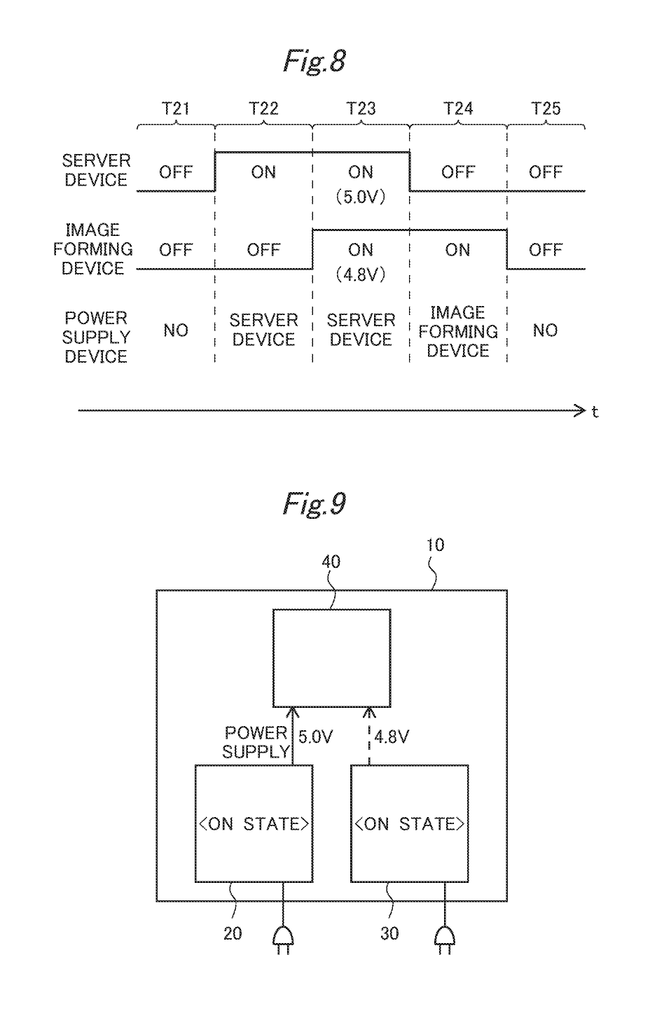

FIG. 8 is a view showing the respective power supply states of the devices 20 and 30, and the power supply device and the like in accordance with the second preferred embodiment.

Specifically, in the case where both the devices 20 and 30 are each in the power-on state (a period T23), the operation display part 40 (the power supply control part 41) determines the power supply device on the basis of the respective output voltages from the power sources 21 and 31 of these devices 20 and 30.

In more detail, the power supply control part 41 acquires the respective output voltages of the power sources 21 and 31 of these devices 20 and 30 immediately after the output voltage from the power source of the device which is changed last to the power-on state, out of the devices 20 and 30, is applied to the operation display part 40. Herein, after the server device 20 is changed to the power-on state, the image forming device 30 is changed to the power-on state. For this reason, the power supply control part 41 acquires the respective output voltages of the power sources 21 and 31 of the devices 20 and 30 by using the voltage detection parts 48 and 49, respectively, immediately after the image forming device 30 is changed to the power-on state and the output voltage from the power source 31 thereof is applied to the operation display part 40.

Then, the power supply control part 41 makes a comparison between the output voltage of the power source 21 and that of the power source 31, and determines the device whose power source has the highest output voltage, out of the devices 20 and 30, as the power supply device. Herein, a voltage of 5.0 V is detected from the power source 21 of the server device 20 and a voltage of 4.8 V is detected from the power source 31 of the image forming device 30. For this reason, the power supply control part 41 determines the server device 20 (the device which supplies the operation display part 40 with a voltage higher than that of the image forming device 30) as the power supply device (also see FIGS. 8 and 9). FIG. 9 is a conceptual diagram relating to determination of the power supply device in the case where both the devices 20 and 30 are each in the power-on state in accordance with the second preferred embodiment.

Further, in a case where either one of the server device 20 and the image forming device 30 is in the power-on state, the operation display part 40 determines one device which is in the power-on state, as the power supply device, and is operated by receiving the power supply from the one device. For example, in a case where only the server device 20 is in the power-on state (a period T22), the server device 20 is determined as the power supply device, and the operation display part 40 is operated by receiving the power supply from the server device 20. Conversely, in a case where only the image forming device 30 is in the power-on state (a period T24), the image forming device 30 is determined as the power supply device, and the operation display part 40 is operated by receiving the power supply from the image forming device 30.

Further, in a case where both the server device 20 and the image forming device 30 are each in the power-off state (periods T21 and T25), like in the first preferred embodiment, no voltage is supplied to the operation display part 40 from any one of the devices, and the operation display part 40 is not operated (in the non-conducting state).

Thus, in the second preferred embodiment, in the case where at least two devices among the plurality of devices are each in the power-on state, the device whose power source has the highest output voltage, out of at least two devices, is determined as the power supply device. For this reason, it is possible to determine a device which can stably supply electric power to the operation display part 40, as the power supply device. It is further possible to stabilize the operation of the operation display part 40.

### Variation of The Second Preferred Embodiment

Further, in the second preferred embodiment, the respective output voltages of the power sources 21 and 31 of the devices 20 and 30 are acquired immediately after the output voltage from the power source of the device which is changed last to the power-on state, out of the server device 20 and the image forming device 30, is applied to the operation display part 40. Then, the device whose power source has the highest output voltage, out of the server device 20 and the image forming device 30, is determined as the power supply device. In short, in the above-described second preferred embodiment, the power supply device is determined on the basis of (only) the respective output voltages (the respective output voltages of the power sources 21 and 31) at the point in time immediately after both the server device 20 and the image forming device 30 are each changed to the power-on state.

Herein, the respective output voltages from the power sources of the devices (the voltages applied to the operation display part 40) are sometimes changed

The image forming device 30, for example, has a processing part (a fixing part of toner, or the like) which consumes relatively high electric power for its operation. For this reason, when the processing part is operating in the image forming device 30, the output voltage from the power source 31 of the image forming device 30 sometimes temporarily becomes unstable. In this case, there is a possibility that the image forming device 30 cannot perform stable supply of electric power to the operation display part 40.

In consideration of this point, there may be a case where the respective output voltages from the power sources 21 and 31 of both the server device 20 and the image forming device 30 are regularly acquired and the power supply device is determined on the basis of the latest output voltages from the power sources 21 and 31. In short, there may be a case where the respective output voltages from the power sources 21 and 31 are regularly acquired and the determination process of the power supply device is performed every time the output voltages are acquired.

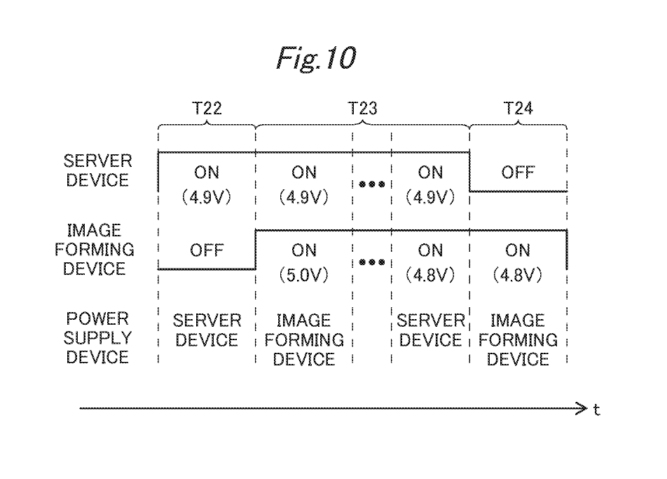

FIG. 10 is a view showing the respective power supply states of the devices 20 and 30, and the power supply device and the like in accordance with a modification of the second preferred embodiment.

For example, after the server device 20 is changed to the power-on state, and further immediately after the image forming device 30 is changed to the power-on state, the power supply control part 41 acquires the respective output voltages from the power sources 21 and 31 of the devices 20 and 30 and determines the power supply device (the period T23). Herein, a voltage of 4.9 V is detected from the power source 21 of the server device 20 and a voltage of 5.0 V is detected from the power source 31 of the image forming device 30. Then, the power supply control part 41 determines the image forming device 30 (the device which supplies a voltage higher than that of the server device 20) as the power supply device, and the operation display part 40 is operated by the power supply from the image forming device 30.

After that, the power supply control part 41 acquires the respective output voltages from the power sources 21 and 31 regularly (for example, at an interval of several minutes) and determines the device whose power source has the highest latest output voltage, out of the devices 20 and 30, as the power supply device every time the power supply control part 41 acquires the output voltages.

It is assumed, for example, that at a point in time in the case where both the devices 20 and 30 are each in the power-on state, the image forming device 30 starts to perform a printing job. Since the image forming device 30 performs the printing job, the output voltage from the power source 31 of the image forming device 30 becomes unstable, and herein a voltage of 4.8 V is detected from the power source 31. In this case, the output voltage (4.8 V) from the power source 31 of the image forming device 30 is lower than the output voltage (4.9 V) from the power source 21 of the server device 20, and the power supply control part 41 determines the server device 20 as the power supply device. Then, the operation display part 40 is operated by the power supply from the server device 20.

Thus, there may be a case where the respective output voltages from the power sources 21 and 31 of the server device 20 and the image forming device 30 are regularly acquired and the power supply device is determined on the basis of the latest output voltages of the power sources 21 and 31. By this method, it is possible to determine the device which can stably supply electric power to the operation display part 40, as the power supply device, in consideration of variations in the respective output voltages from the power sources 21 and 31 of the devices 20 and 30.

### 3. The Third Preferred Embodiment

The third preferred embodiment is a variation of the first preferred embodiment. Hereinafter, discussion will be made, centering on the difference between the first and third preferred embodiments.

In this preferred embodiment, any one of the devices 20 and 30 (herein, both of the devices 20 and 30) can be changed from a normal mode to a power saving mode in a case where the device does (the devices do) not perform any operation over a certain period. Further, the power saving mode (also referred to as a sleep mode) is a mode in which the device operates with a power consumption lower than a power consumption used in the normal mode.

Specifically, the respective operation control parts 29c and 39c (FIGS. 3 and 4) of the devices 20 and 30 switch the supply destinations of the electric powers (voltages) from the power sources 21 and 31 of the devices 20 and 30 in accordance with the states of electric power mode of the devices 20 and 30, respectively. For example, in a case where the self-device is in the normal mode, each of the operation control parts 29c and 39c controls the supply destination of the electric power so that the electric power can be supplied from the power source of the self-device to all the processing parts (including the touch panel 45 and the like of the operation display part 40) in the self-device. Conversely, in a case where the self-device is in the power saving mode, each of the operation control parts 29c and 39c of the devices 20 and 30 controls the supply destination of the electric power so that the electric power should be supplied to some of the processing parts (e.g., the communication part) in the self-device and should not be supplied to the other processing parts (including the touch panel 45 and the like) in the self-device from the power source of the self-device. With such controls, in the case where the devices 20 and 30 are each in the power saving mode, the supply destinations of the electric power are reduced (narrowed down) as compared with the supply destinations of the electric power in the normal mode, and the power consumption is reduced (saved) in the devices 20 and 30 (MFP 10).

Further, in this preferred embodiment, each of the devices 20 and 30 can be changed from the normal mode to the power saving mode on the condition that no electric power is supplied to the operation display part 40 from the power source of the self-device. In other words, even in a case where a device is changed to the power saving mode since the device does not perform any operation over a certain period, when the device supplies electric power to the operation display part 40, the device is not changed to the power saving mode. In short, though the device can be changed to the power saving mode originally, the device is not changed to the power saving mode and kept in the normal mode in order to supply electric power to the operation display part 40. As a result, there is a possibility that the power consumption cannot be reduced (saved) in the device.

Because of such circumstances, it is preferable that the supply of electric power to the operation display part 40 should be performed by a device which has the lowest possibility of being changed to the power saving mode, out of the devices which are each in the power-on state. In other words, it is preferable that the supply of electric power to the operation display part 40 should be performed by a device which has the highest possibility of keeping the normal mode, out of the devices which are each in the power-on state.

In the third preferred embodiment, in the case where at least two devices among the plurality of devices are each in the power-on state, a device which has the lowest possibility of being changed to the power saving mode, out of at least two devices, is determined as the power supply device.

Specifically, when a device performs display output on the operation display part 40, the device has a relatively high possibility of being operated (used) by the user. Conversely, a device which does not perform any display output has a relatively low possibility of being operated (used) by the user.

For this reason, it can be thought that a device (also referred to as a currently-displaying device) which performs display output on the operation display part 40 has a possibility of being changed to the power saving mode (also referred to as a power-saving change possibility) which is lower than that of a non-currently-displaying device.

In consideration of these points, in the third preferred embodiment, the device (currently-displaying device) which performs display output on the operation display part 40, out of the devices 20 and 30, is determined as the power supply device.

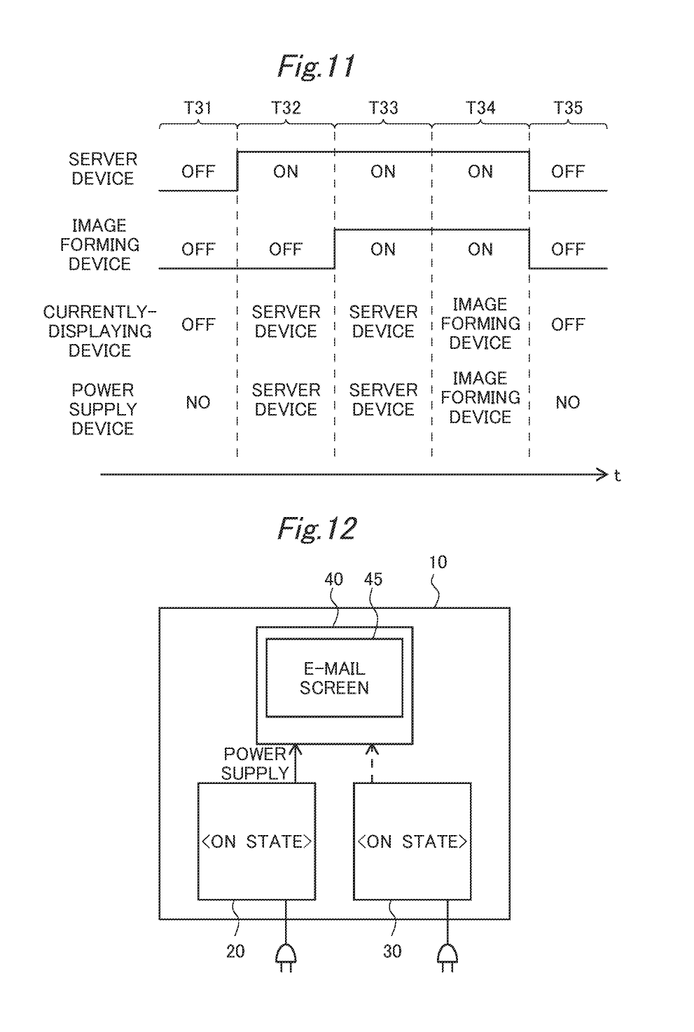

FIG. 11 is a view showing respective power supply states of the devices 20 and 30, and the power supply device and the like in accordance with the third preferred embodiment.

Specifically, in the case where both the devices 20 and 30 are each in the power-on state, the power supply control part 41 specifies the currently-displaying device on the basis of which device gives image data which is displayed on the touch panel 45 and specifies the currently-displaying device as the device which has the lowest power-saving change possibility, out of the devices 20 and 30 which are each in the power-on state. Then, the power supply control part 41 determines the currently-displaying device as the power supply device. In more detail, the power supply control part 41 determines (considers) that the power-saving change possibility of the device which is specified as the currently-displaying device is lower than that of the device other than the currently-displaying device, out of the devices 20 and 30, and determines the currently-displaying device as the power supply device. After that, the operation display part 40 is operated by receiving the power supply (the supply of electric power) from the device which is determined as the power supply device.

For example, in the case where both the devices 20 and 30 are each in the power-on state, when the image data from the server device 20 is displayed on the touch panel 45 (a period T33), the power supply control part 41 specifies the server device 20 as the currently-displaying device. Then, the power supply control part 41 determines that the power-saving change possibility of the server device 20 (the currently-displaying device) is lower than that of the image forming device 30 (the other device), and determines the server device 20 as the power supply device. After that, the power supply control part 41 controls the operations of the changeover switches in the same manner as that in the first preferred embodiment (also see FIG. 22), and the operation display part 40 is operated by receiving the power supply from the server device 20 (the currently-displaying device) (also see FIG. 12). Further, FIG. 12 is a conceptual diagram relating to determination of the power supply device in the case where both the devices 20 and 30 are each in the power-on state in accordance with the third preferred embodiment.

Furthermore, in the case where both the devices 20 and 30 are each in the power-on state, for example, when the image data from the image forming device 30 is displayed on the touch panel 45 (a period T34), the power supply control part 41 specifies the image forming device 30 as the currently-displaying device. Then, the power supply control part 41 determines that the power-saving change possibility of the image forming device 30 (the currently-displaying device) is lower than that of the server device 20 (the other device), and determines the image forming device 30 as the power supply device. After that, the power supply control part 41 controls the operations of the changeover switches in the same manner as that in the first preferred embodiment (also see FIG. 23), and the operation display part 40 is operated by receiving the power supply from the image forming device 30 (the currently-displaying device).

Further, in the case where either one of the devices 20 and 30 is in the power-on state, the operation display part 40 determines one device which is in the power-on state, as the power supply device, and is operated by receiving the power supply from the one device. When only the server device 20 is in the power-on state (a period T32), for example, the server device 20 is determined as the power supply device, and the operation display part 40 is operated by receiving the power supply from the server device 20. Conversely, when only the image forming device 30 is in the power-on state (not shown), the image forming device 30 is determined as the power supply device, and the operation display part 40 is operated by receiving the power supply from the image forming device 30.

Furthermore, in the case where both the devices 20 and 30 are each in the power-off state, for example (periods T31 and T35), like in the first preferred embodiment, no voltage is supplied to the operation display part 40 from any one of the devices and the operation display part 40 is not operated.

Thus, in the third preferred embodiment, in the case where at least two devices among the plurality of devices are each in the power-on state, the device (the currently-displaying device) which performs display output on the operation display part 40 is specified as the device which has the lowest possibility of being changed to the power saving mode, out of at least two devices. Then, the currently-displaying device is determined as the power supply device. In short, the device which can keep the normal mode longer than the other device is determined as the power supply device. For this reason, the mode change in the other device which can be changed from normal mode to the power saving mode earlier than the currently-displaying device is not prevented. Therefore, it is possible to determine the power supply device in consideration of power saving in the MFP 10.

### The First Modification of The Third Preferred Embodiment

Further, in the third preferred embodiment, when at least two devices among the plurality of devices are each in the power-on state, the device (currently-displaying device) which performs display output on the operation display part 40, out of the two devices, is determined as the power supply device, but this is only one exemplary case.

Herein, when a device is performing a predetermined operation (for example, performing a job) (for example, when the image forming device 30 is performing the printing job), it can be thought that the power-saving change possibility of the device (the possibility that the device may be changed to the power saving mode) is lower than that of another device which is not performing the predetermined operation.

In consideration of this point, when at least two devices among the plurality of devices are each in the power-on state, the device which is performing the predetermined operation (also referred to as a currently-predetermined operating device), out of at least two devices, may be determined as the power supply device.

Specifically, prior to start of the predetermined operation in the self-device, each of the devices 20 and 30 sends an operation start notification to the operation display part 40.

For example, when the image forming device 30 receives a printing job from an external device or the like, the image forming device 30 sends an operation start notification (job execution start notification) indicating that execution of the printing job is started to the operation display part 40 (the power supply control part 41) through a signal line (not shown) connecting the image forming device 30 to the operation display part 40.

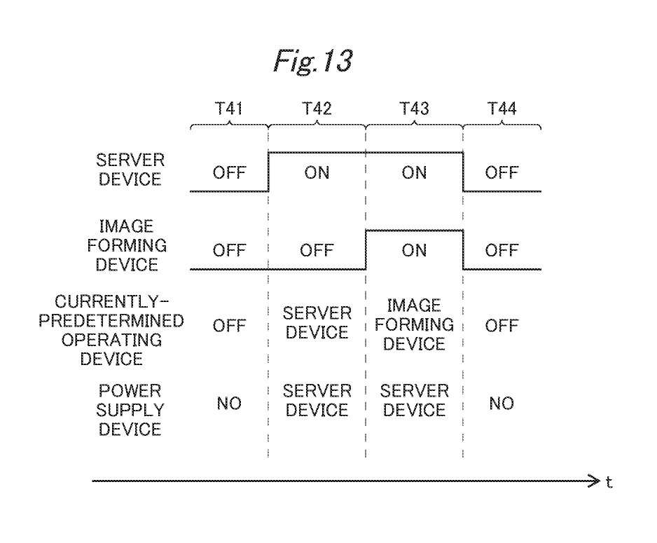

After that, when both the devices 20 and 30 are each in the power-on state, the power supply control part 41 specifies the image forming device 30 as the currently-predetermined operating device (currently-job-executing device) and specifies the currently-predetermined operating device as the device which has the lowest power-saving change possibility out of the devices 20 and 30. Then, the power supply control part 41 determines the device (the image forming device 30) which is determined as the currently-predetermined operating device, as the power supply device (see a period T43 of FIG. 13). Specifically, the power supply control part 41 determines (considers) that the power-saving change possibility of the device (the image forming device 30) which is specified as the currently-predetermined operating device is lower than that of the device other than the currently-predetermined operating device, out of the devices 20 and 30, and determines the currently-predetermined operating device as the power supply device. After that, the operation display part 40 is operated by receiving the power supply from the image forming device 30.

Further, in the case where at least two devices are each in the power-on state, when there is no device which is performing the predetermined operation, out of at least two devices, for example, like in the third preferred embodiment, the device which performs display output on the operation display part 40 may be determined as the power supply device.

Thus, in the case where at least two devices among the plurality of devices are each in the power-on state, the device which performs the predetermined operation (in detail, the device which performs a job), out of the two devices, may be determined as the power supply device.

By this method, the device (currently-predetermined operating device) which can keep the normal mode longer than the other device is determined as the power supply device. For this reason, the mode change in the other device which can be changed from normal mode to the power saving mode earlier than the currently-predetermined operating device is not prevented. Therefore, it is possible to determine the power supply device in consideration of power saving in the MFP 10.

### The Second Modification of The Third Preferred Embodiment

Herein, even in the case where a display processing relating to the currently-displaying device is performed on the operation display part 40, the currently-displaying device is sometimes not operated (used) by the user. When the currently-displaying device is not operated by the user, there is a possibility that the currently-displaying device may be changed from the normal mode to the power saving mode.

On the other hand, the currently-predetermined operating device (currently-job-executing device) is a device which is currently performing a predetermined operation (job) and it can be thought that the power-saving change possibility of the currently-predetermined operating device (the possibility that the device may be changed to the power saving mode) is lower than that of the currently-displaying device.

In consideration of this point, in the case where at least two devices among the plurality of devices are each in the power-on state, when one device different from the currently-displaying device is performing a predetermined operation, the one device (the currently-predetermined operating device), instead of the currently-displaying device, may be determined as the power supply device.

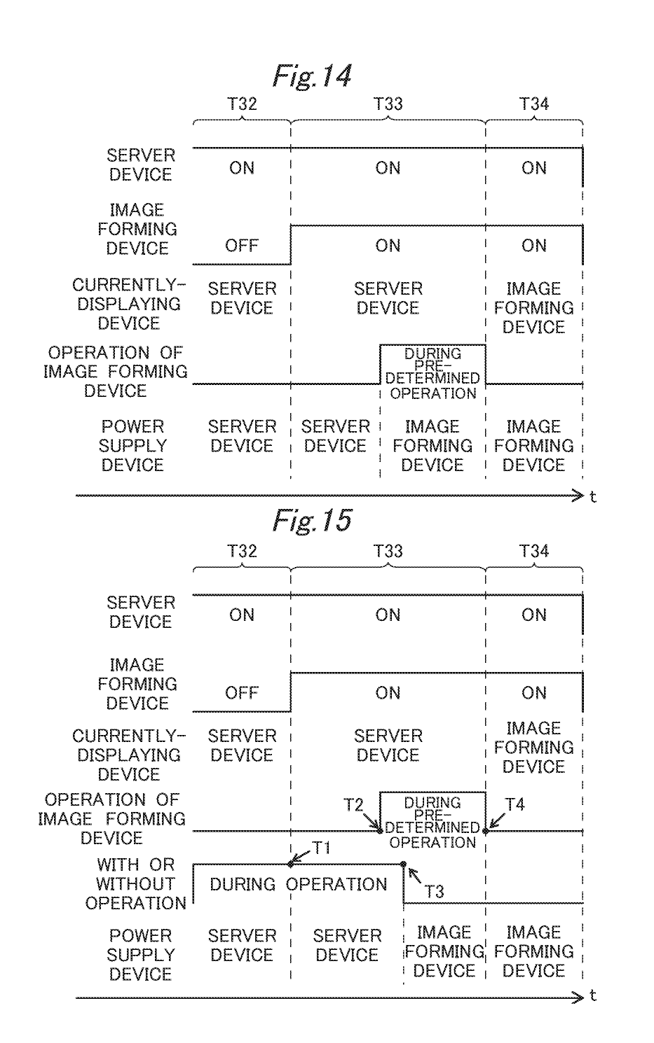

FIG. 14 is a view showing respective power supply states of the devices 20 and 30, and the power supply device and the like in accordance with the second modification of the third preferred embodiment. Herein, attention is paid to the period T33 of FIG. 14.

In the period T33, both the server device 20 and the image forming device 30 are each in the power-on state, and a display processing relating to the server device 20 is performed on the operation display part 40.

In this case, when the image forming device 30 is not performing any job, for example, the power supply control part 41 determines the currently-displaying device (herein, the server device 20), out of the devices 20 and 30, as the power supply device like in the third preferred embodiment.

After that (within the period T33), for example, when the image forming device 30 is performing a job, the power supply control part 41 specifies the currently-job-executing device (the image forming device 30), instead of the currently-displaying device (the server device 20), as the device which has the lowest power-saving change possibility among the devices 20 and 30 which are each in the power-on state. Then, the power supply control part 41 determines the currently-job-executing device (the image forming device 30) as the power supply device. In more detail, the power supply control part 41 determines (considers) that the power-saving change possibility of the currently-job-executing device (the image forming device 30) is lower than that of the currently-displaying device (server device 20) and determines the currently-job-executing device (the image forming device 30) as the power supply device.

Thus, in the case where at least two devices among the plurality of devices are each in the power-on state, when one device different from the currently-displaying device is performing a predetermined operation (job execution operation or the like), the one device, instead of the currently-displaying device, may be determined as the power supply device.

By this method, it is possible to determine the device which has a lower possibility of being changed to the power saving mode, out of at least two devices which are each in the power-on state, as the power supply device.

Herein, in the case where a display processing relating to the currently-displaying device is performed on the operation display part 40, it is determined, in the currently-displaying device, that a period from the start of the display until a certain non-operation period elapses is a period (user operation period) while the currently-displaying device is operated by the user using the operation display part 40. For this reason, during the operation period, it is considered that the currently-displaying device is used by the user, and the possibility that the currently-displaying device may be changed to the power saving mode is relatively low.

In consideration of this point, as to the above-described second modification, within the period (operation period) while it is determined that an operation input of the user is performed by using the operation display part 40, the currently-displaying device may be determined as the power supply device, regardless of whether any device other than the currently-displaying device performs a predetermined operation or not.

FIG. 15 is a view showing respective power supply states of the devices 20 and 30, and the power supply device and the like in accordance with this modification. Herein, attention is paid to the period T33 of FIG. 15.

In the period T33, both the server device 20 and the image forming device 30 are each in the power-on state, and a display processing relating to the server device 20 is performed on the operation display part 40. Further, a period from a time T1 to a time T3 within the period T33 is within the user operation period, and in a period from a time T2 to a time T4, the image forming device 30 performs a job.

In this case, in the period from the time T1 to the time T3 within the period T33 (in other words, the user operation period), the currently-displaying device (the server device 20), out of the devices 20 and 30, is determined as the power supply device, regardless of whether the image forming device 30 performs any job or not. Particularly, in the period from the time T2 to the time T4 within the period T33, even when the image forming device 30 performs a job, the currently-displaying device (the server device 20) is preferentially determined as the power supply device.

Thus, within the user operation period in the operation display part 40, the currently-displaying device may be determined as the power supply device, regardless of whether the device other than the currently-displaying device performs a predetermined operation or not. Further, after the operation period is finished (in a period from the time T3 to the time T4), the currently-job-executing device (the image forming device 30) is determined as the power supply device.

### 4. The Fourth Preferred Embodiment

The fourth preferred embodiment is a variation of the first preferred embodiment. Hereinafter, discussion will be made, centering on the difference between the first and fourth preferred embodiments.

In the image forming device 30, when a predetermined job (job consuming electric power not lower than a predetermined degree) is performed, the output voltage of the power source 31 in the image forming device 30 sometimes temporarily becomes unstable. When the image forming device 30 performs the printing job, for example, relatively high electric power is consumed in the fixing part of toner, a motor part for paper conveyance, and the like, and the output voltage of the power source 31 sometimes temporarily becomes unstable. In this case, there is a possibility that the image forming device 30 cannot perform stable power supply to the operation display part 40.

In consideration of this point, in the fourth preferred embodiment, in the case where both the server device 20 and the image forming device 30 are each in the power-on state, when the image forming device 30 is performing the predetermined job, the device (the server device 20) other than the image forming device 30, out of the devices 20 and 30, is determined as the power supply device. In other words, in the case where at least two devices among the plurality of devices are each in the power-on state, when the image forming device 30 is performing the printing job, the image forming device 30 is excluded from the candidates for the power supply device.

Further, there is a difference in the principle (basis) for determination of the power supply device between the above-described third preferred embodiment and this fourth preferred embodiment. Specifically, in the above-described third preferred embodiment, the power supply device is determined on the basis of the possibility of being changed to the power saving mode in each device. On the other hand, in this fourth preferred embodiment, the power supply device is determined on the basis of the output voltage (the stability for the supply of electric power) from the power source in each device. For this reason, the device which is determined as the power supply device on the basis in the above-described third preferred embodiment is not sometimes determined as the power supply device in this fourth preferred embodiment. Conversely, the device which is not determined as the power supply device on the basis in the above-described third preferred embodiment is sometimes determined as the power supply device in this fourth preferred embodiment.

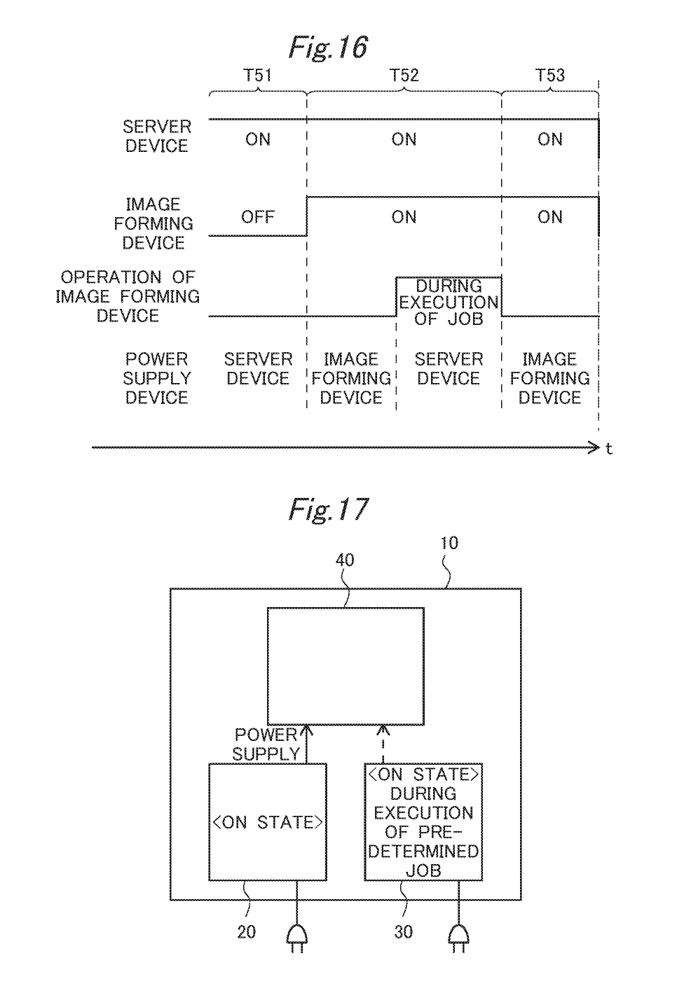

FIG. 16 is a view showing respective power supply states of the devices 20 and 30, and the power supply device and the like in accordance with the fourth preferred embodiment.

In the case where both the devices 20 and 30 are each in the power-on state (a period T52), for example, when the image forming device 30 is not performing the predetermined job (for example, the printing job), the device (herein, the image forming device 30) which is determined in advance is determined as the power supply device like in the first preferred embodiment.

After that, when the image forming device 30 starts execution of the predetermined job (printing job), the image forming device 30 sends the job execution start notification to the operation display part 40 (the power supply control part 41) through the signal line (not shown) connecting the image forming device 30 to the operation display part 40. Then, in response to the job execution start notification, the power supply control part 41 determines the device (the server device 20) other than the image forming device 30, out of the devices 20 and 30 which are each in the power-on state, as the power supply device (also see FIG. 17). Further, FIG. 17 is a conceptual diagram relating to determination of the power supply device in the case where both the devices 20 and 30 are each in the power-on state in accordance with the fourth preferred embodiment.

Thus, in the fourth preferred embodiment, in the case where at least two devices among the plurality of devices are each in the power-on state, when the image forming device 30 is performing the job consuming electric power not lower than a predetermined degree, the device other than the image forming device 30, out of at least two devices, is determined as the power supply device. In other words, when there is a possibility that the image forming device 30 cannot stably perform the supply of voltage to the operation display part 40, the image forming device 30 is excluded from the candidates for the power supply device and the other device (the server device 20) which is in the power-on state is determined as the power supply device. Therefore, it is possible to determine the device which can stably perform the power supply to the operation display part 40, as the power supply device.

### The First Modification of The Fourth Preferred Embodiment

Though the printing job is exemplarily shown as the predetermined job consuming electric power not lower than a predetermined degree herein, this is only one exemplary case and the predetermined job may be an image reading job.

Specifically, when the image forming device 30 is performing the image reading job, relatively high electric power is consumed in the image reading part 32, a motor part for paper conveyance, and the like. As a result, when the image forming device 30 is performing the image reading job, the output voltage of the power source 31 in the image forming device 30 sometimes becomes unstable. In other words, when the image forming device 30 is performing the image reading job, there is a possibility that the image forming device 30 cannot perform stable power supply to the operation display part 40.

In consideration of this point, in the case where at least two devices among the plurality of devices are each in the power-on state, when the image forming device 30 is performing the image reading job, the device (herein, the server device 20) other than the image forming device 30, out of at least two devices, is determined as the power supply device.

### The Second Modification of The Fourth Preferred Embodiment

Further, not only in the case where the image forming device 30 is performing the predetermined job but also in the following case, the device other than the image forming device 30, out of at least two devices which are each in the power-on state, may be determined as the power supply device.

In the case where at least two devices among the plurality of devices are each in the power-on state, for example, when a preparing operation (described later) of the predetermined job is detected in the image forming device 30, the device other than the image forming device 30, out of at least two devices, may be determined as the power supply device.

Herein, in a case where an operation of the user for placing an original manuscript on the ADF is detected, for example, there is a relatively high possibility that the predetermined job (the image reading job or the printing job) consuming electric power not lower than a predetermined degree may be performed immediately after that. When the image forming device 30 is performing the predetermined job, as described above, the output voltage of the power source 31 in the image forming device 30 sometimes becomes unstable. In other words, when the preparing operation performed prior to execution of the predetermined job (the preparing operation to the operation member (the ADF or the like) included in the image forming device 30) is detected, there is a relatively high possibility that the output voltage of the power source 31 in the image forming device 30 may become unstable immediately after the detection.

In consideration of this point, in the case where at least two devices among the plurality of devices are each in the power-on state, when the preparing operation is detected in the image forming device 30, the device other than the image forming device 30, out of at least two devices, may be determined as the power supply device.

Specifically, in the case where both the server device 20 and the image forming device 30 are each in the power-on state, when the user places an original manuscript on the ADF of the image forming device 30, for example, the operation detection part 36 of the image forming device 30 detects the operation of placing the original manuscript as the preparing operation for the predetermined job. Then, the image forming device 30 notifies the operation display part 40 (the power supply control part 41) that the preparing operation is detected and in response to the preparing operation, the power supply control part 41 determines the device (the server device 20) other than the image forming device 30, out of the devices 20 and 30 which are each in the power-on state, as the power supply device.

Thus, in the case where both the devices 20 and 30 are each in the power-on state, when the preparing operation for the predetermined job is detected in the image forming device 30, the device other than the image forming device 30, out of the devices 20 and 30, may be determined as the power supply device. By this method, it is possible to determine the power supply device, avoiding the device which has a relatively high possibility that the voltage to be supplied to the operation display part 40 will become unstable in the near future.

### The Third Modification of The Fourth Preferred Embodiment

Further, in the case where at least two devices among the plurality of devices are each in the power-on state, when the image forming device 30 is performing a startup process, the device other than the image forming device 30, out of at least two devices, may be determined as the power supply device.

Herein, in the image forming device 30, the self-device 30 is changed from the power-off state to the power-on state and starts up, an initialization process (an image stabilization process, a temperature increasing process of the fixing part, and the like) is performed. In this initialization process, a relatively high electric power (electric power not lower than a predetermined degree) is consumed. For this reason, when the image forming device 30 is performing the startup process (performing the initialization process), the output voltage of the power source 31 in the image forming device 30 sometimes becomes unstable.

In consideration of this point, in the case where at least two devices among the plurality of devices are each in the power-on state, when the image forming device 30 is performing the startup process, the device other than the image forming device 30, out of at least two devices, may be determined as the power supply device.

Specifically, in the case where both the server device 20 and the image forming device 30 are each in the power-on state, when the image forming device 30 is performing the startup process (including the initialization process), the device (the server device 20) other than the image forming device 30, out of the devices 20 and 30, may be determined as the power supply device.

By this method, it is possible to determine the device which can stably perform the power supply to the operation display part 40 as the power supply device.

### 5. The Fifth Preferred Embodiment

The fifth preferred embodiment is a variation of the first preferred embodiment. Hereinafter, discussion will be made, centering on the difference between the first and fifth preferred embodiments.

In the above-described first preferred embodiment, the power supply device is determined on the basis of the respective power supply states of the devices 20 and 30 (whether each of the devices 20 and 30 is in the power-on state or the power-off state).

In this fifth preferred embodiment, the power supply device is determined on the basis of respective electric power modes of the devices 20 and 30 (whether each of the devices 20 and 30 is in a normal mode or a power saving mode).

Further, in this preferred embodiment, each of the server device 20 and the image forming device 30 can supply electric power to the operation display part 40 from the power source thereof on the condition that the device is in the normal mode.

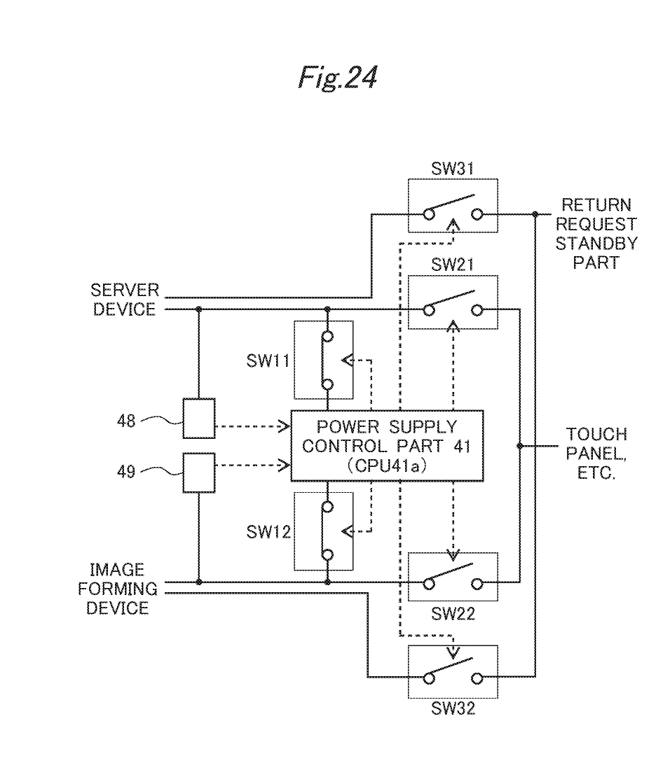

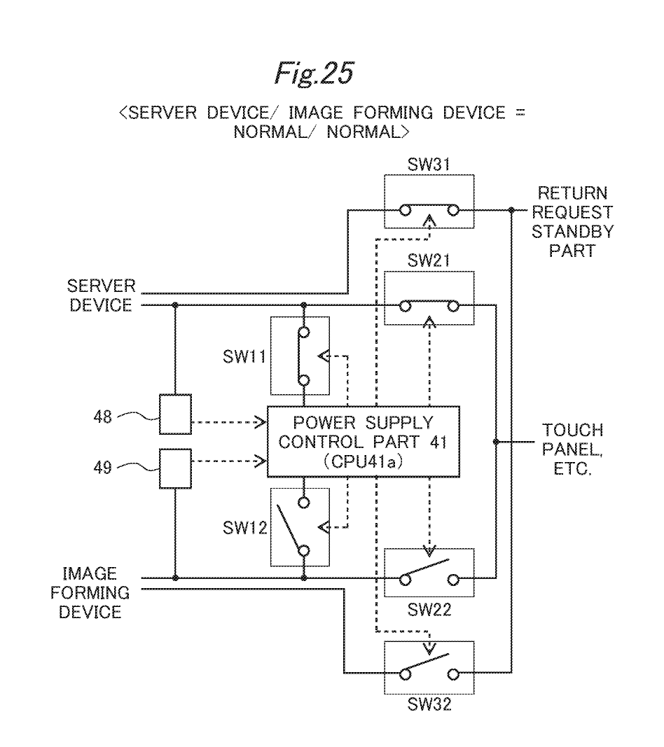

FIGS. 24 to 27 are control circuit diagrams each relating to determination control of the power supply device, and the like, in accordance with the fifth preferred embodiment.

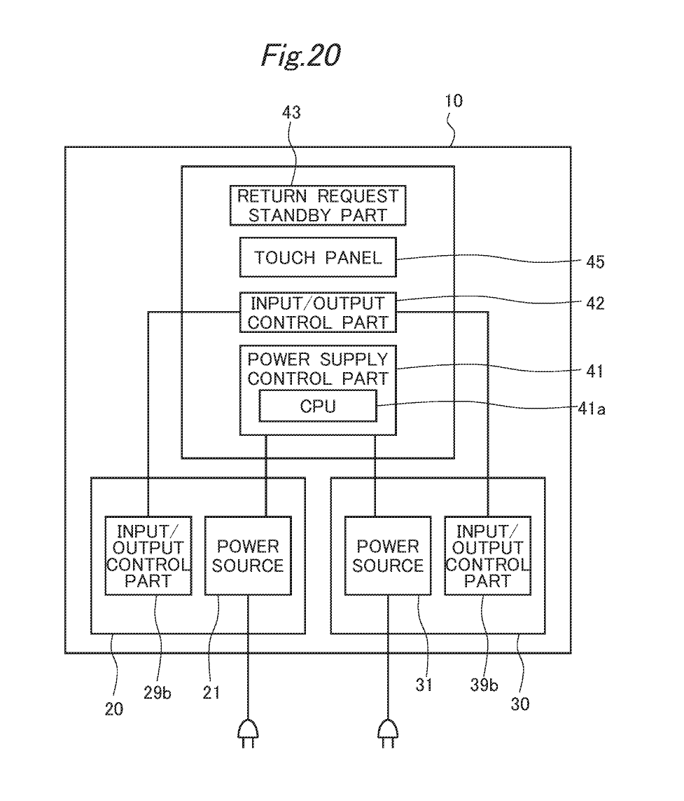

In this fifth preferred embodiment, a return request standby part 43 (also see FIG. 20) is provided in the operation display part 40. Further, the detailed description of the return request standby part 43 will be made later.

The power supply control part 41 further has changeover switches SW31 and SW32 (FIG. 24) and sends the switching signal to each of the changeover switches, to thereby control an operation of the changeover switch.

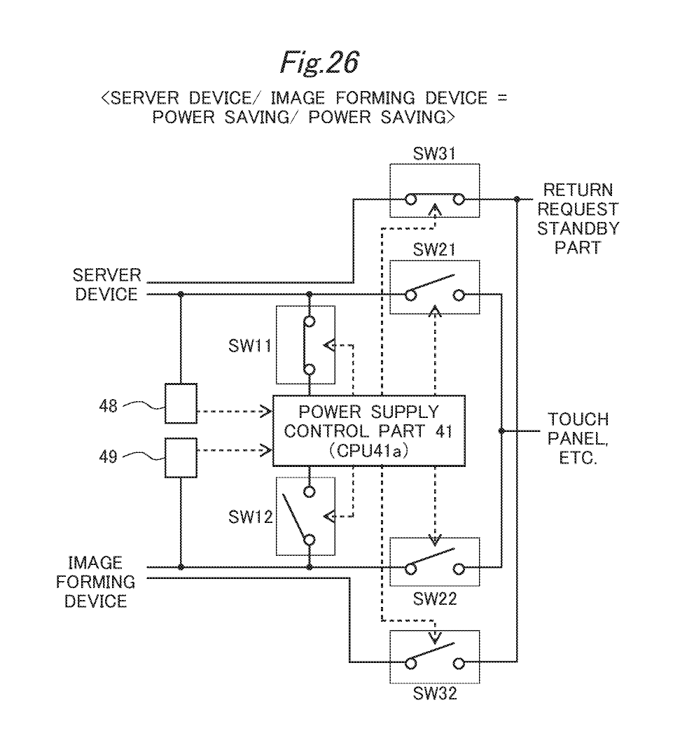

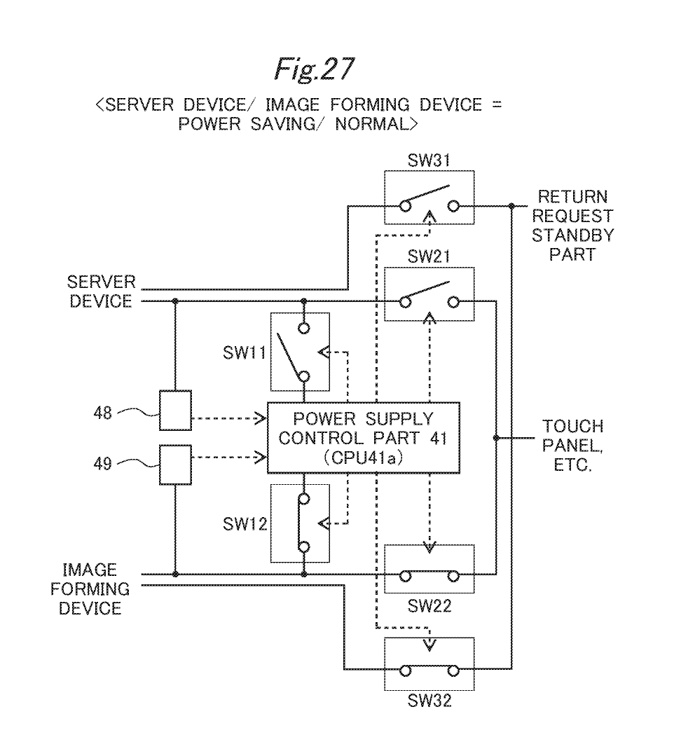

The second SW31 is a switching part for switching between ON/OFF (open state/closed state) of an input circuit for supplying the output voltage from the power source 21 of the server device 20 to the return request standby part 43. When the changeover switch SW31 is in the closed state (see FIGS. 25 and 26), the output voltage from the power source 21 of the server device 20 is supplied to the return request standby part 43. Conversely, when the changeover switch SW31 is in the open state (see FIG. 27), the output voltage from the power source 21 of the server device 20 is not supplied to the return request standby part 43.

The changeover switch SW32 is a switching part for switching between ON/OFF (open state/closed state) of an input circuit for supplying the output voltage from the power source 31 of the image forming device 30 to the return request standby part 43. When the changeover switch SW32 is in the closed state (see FIG. 27), the output voltage from the power source 31 of the image forming device 30 is supplied to the return request standby part 43. Conversely, when the changeover switch SW32 is in the open state (see FIGS. 25 and 26), the output voltage from the power source 31 of the image forming device 30 is not supplied to the return request standby part 43.

Further, in this preferred embodiment, each of the respective operation control parts 29c and 39c of the devices 20 and 30 controls the supply destination of the electric power so that the electric power should be supplied to the touch panel 45 and the like and the return request standby part 43 of the operation display part 40 from the power source of the self-device when the self-device is in the normal mode. On the other hand, each of the respective operation control parts 29c and 39c of the devices 20 and 30 controls the supply destination of the electric power so that the electric power should not be supplied to the touch panel 45 and the like of the operation display part 40 and the electric power should be supplied to the return request standby part 43 from the power source of the self-device when the self-device is in the power saving mode.

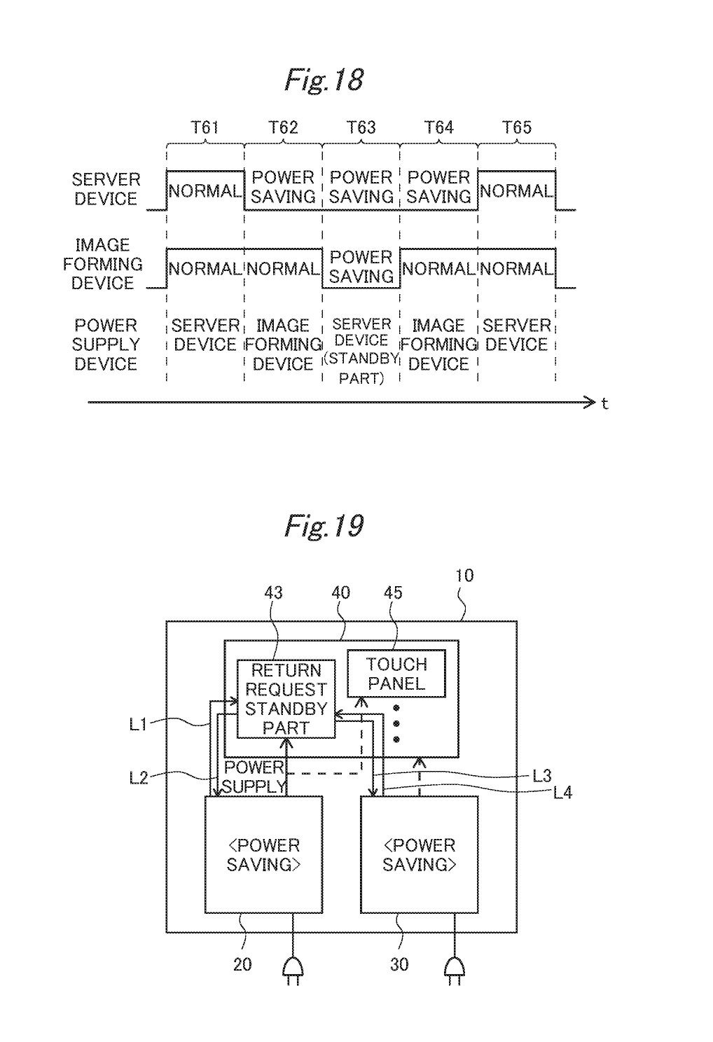

FIG. 18 is a view showing respective electric power modes (electric power mode states) of the devices, and the power supply device and the like. Hereinafter, with reference to FIGS. 18, 24 to 27, and the like, an operation of the fifth preferred embodiment will be described.

Specifically, in a period T61 of FIG. 18, both the server device 20 and the image forming device 30 are each in the normal mode. In this case, the operation display part 40 (the power supply control part 41) determines the device (herein, the server device 20) which is determined in advance, as the power supply device, for example, like in the first preferred embodiment. Then, the power supply control part 41 controls the changeover switches SW11, SW21, and SW31 to be in the closed state and controls the changeover switches SW12, SW22, and SW32 to be in the open state (see FIG. 25). The output voltage from the power source 21 of the server device 20 is thereby supplied to the return request standby part 43 and the touch panel 45 and the like, and the operation display part 40 is operated by the power supply from the power source 21 of the server device 20.

Further, herein, in the case where both the server device 20 and the image forming device 30 are each in the normal mode, the power supply device is determined by the same operation as that in the first preferred embodiment, but this is only one exemplary case and in the case where both the server device 20 and the image forming device 30 are each in the normal mode, the power supply device may be determined by the same operation as any one of those in the other preferred embodiments and the like. For example, in the case where both the server device 20 and the image forming device 30 are each in the normal mode, the power supply device may be determined on the basis of the respective output voltages from the power sources 21 and 31 of the devices 20 and 30 like in the second preferred embodiment.

After that, it is assumed that the server device 20 is changed from the normal mode to the power saving mode on the condition that the server device 20 does not perform any operation over a certain period, or the like.

When the server device 20 is changed from the normal mode to the power saving mode (a period T62 in FIG. 18), the operation display part 40 (the power supply control part 41) determines the device (herein, the image forming device 30) which is in the normal mode, as the power supply device. In other words, in a case where there are a device which is in the normal mode and another device which is in the power saving mode among a plurality of devices (a period T62), the power supply control part 41 determines the device (herein, the image forming device 30) which is in the normal mode, as the power supply device.

Specifically, the server device 20 gives a power saving mode change notification indicating that the server device 20 is changed from the normal mode to the power saving mode, to the operation display part 40 (the power supply control part 41). When the power supply control part 41 receives the power saving mode change notification from the server device 20, the power supply control part 41 determines another device (the image forming device 30) which is in the normal mode, as the power supply device. Then, the power supply control part 41 controls the changeover switches so that the changeover switches SW12, SW22, and SW32 should be in the closed state and the changeover switches SW11, SW21, and SW31 should be in the open state (see FIG. 27). The output voltage from the power source 31 of the image forming device 30 is thereby supplied to the whole operation display part 40 (the power supply control part 41, the return request standby part 43, the touch panel 45, and the like), and the operation display part 40 is (continuously) operated by power supply from the power source 31 of the image forming device 30.

Further after that, it is assumed that the image forming device 30 is also changed from the normal mode to the power saving mode on the condition that the image forming device 30 does not perform any operation over a certain period, or the like.

Specifically, in a case where there is no device which is in the normal mode among the plurality of devices (a period T63 in FIG. 18), the power supply control part 41 first determines one device which is in the power saving mode, as the power supply device. In more detail, for example, like in the first preferred embodiment and the like, the power supply control part 41 determines the device (herein the server device 20) which is determined in advance, out of the server device 20 and the image forming device 30, as the power supply device.

Though the power supply device is determined by the same operation as that in the first preferred embodiment herein when both the devices 20 and 30 are each in the power saving mode, this is only one exemplary case. When both the devices 20 and 30 are each in the power saving mode, for example, the power supply device may be determined on the basis of the respective output voltages of the power sources 21 and 31 like in the second preferred embodiment and the like.

Then, the power supply control part 41 performs control so that the voltage should be supplied from the power supply device to some processing parts (the return request standby part 43 (described below) (see FIGS. 19 and 20)) in the operation display part 40, not so that the voltage should be supplied from the power supply device to all the processing parts in the operation display part 40. FIG. 19 is a conceptual diagram relating to determination of the power supply device in the case where both the devices 20 and 30 are each in the power saving mode.

The return request standby part 43 is a processing part which is capable of waiting a return request command indicating that a device which is in the power saving mode should be returned to the normal mode. For example, the return request standby part 43 is composed of a hardware processor and the like. In the MFP 10, the return request command is given from each device to the return request standby part 43 of the operation display part 40. Then, the return request standby part 43 gives the return request command to the device which is in the power saving mode, and in response to the return request command from the operation display part 40, the device is returned from the power saving mode to the normal mode.

Further, each device is connected to the return request standby part 43 with the signal line, and the return request command is given and received through the signal line. Specifically, the return request command is given and received between the server device 20 and the return request standby part 43 through signal lines L1 and L2 (see FIG. 19). Furthermore, the return request command is given and received between the image forming device 30 and the return request standby part 43 through signal lines L3 and L4 (see FIG. 19).

In the case where the image forming device 30 is in the power saving mode, for example, when the printing job (for example, a facsimile reception printing job) is received from an external device or the like, the communication part 34 (FIG. 3) of the image forming device 30 gives the return request command to the return request standby part 43 of the operation display part 40 through the signal line L4. When the return request standby part 43 acquires the return request command from the image forming device 30, the return request standby part 43 gives the return request command to the operation control part 39c (FIG. 3) of the image forming device 30 through the signal line L3. Then, in response to the return request command, the operation control part 39c of the image forming device 30 causes the power source 31 of the self-device 30 to perform (resume) the supply of electric power to the processing parts (the processing parts which are each in a power saving state) in the self-device 30. The image forming device 30 is thereby returned from the power saving mode to the normal mode. Then, the image forming device 30 performs the printing job which is received.

Further, in the case where the server device 20 is in the power saving mode, for example, when a request for storing data is received from an external device or the like, the communication part 24 (FIG. 4) of the server device 20 gives the return request command to the return request standby part 43 of the operation display part 40 through the signal line L1. When the return request standby part 43 acquires the return request command from the server device 20, the return request standby part 43 gives the return request command to the operation control part 29c (FIG. 4) of the server device 20 through the signal line L2. Then, in response to the return request command, the operation control part 29c of the server device 20 causes the power source 21 of the self-device 20 to perform (resume) the supply of electric power to the processing parts (the processing parts which are each in the power saving state) in the self-device 20. The server device 20 is thereby returned from the power saving mode to the normal mode. Then, the server device 20 stores the data relating to the storage request into the self-device 20 or the like.

Furthermore, there is a case where one device (for example, the server device 20) returns the other device (for example, the image forming device 30) which is in the power saving mode to the normal mode. In a case where the MFP 10 has an apparatus configuration in which the server device 20 receives a job for the image forming device 30 from an external device and transmits the job to the image forming device 30, for example, the server device 20 sometimes returns the image forming device 30 which is in the power saving mode to the normal mode.

Specifically, in a case where the image forming device 30 is in the power saving mode when the server device 20 receives a job (job for the image forming device 30) from an external device, the server device 20 returns the image forming device 30 to the normal mode. Then, after the image forming device 30 is returned to the normal mode, the server device 20 transmits the job received from the external device to the image forming device 30.

In more detail, when the server device 20 receives the printing job (the job to be executed by the image forming device 30) from the external device, the server device 20 gives the return request command for the image forming device 30 to the return request standby part 43 of the operation display part 40 through the signal line L1 (FIG. 19). When the return request standby part 43 acquires the return request command from the server device 20, the return request standby part 43 gives the return request command to the image forming device 30 through the signal line L3. Then, in response to the return request command, the image forming device 30 performs the supply of electric power from the power source 31 of the self-device 30 to the processing parts (the processing parts which are each in the power saving state) in the self-device 30. The image forming device 30 is thereby returned from the power saving mode to the normal mode. Then, the server device 20 transmits the job (herein, the printing job) which is received from the external device to the image forming device 30, and the image forming device 30 performs the printing job.

Further, in a case where the server device 20 is also in the power saving mode when the server device 20 receives the printing job or the like from an external device, the server device 20 gives both the return request command for the image forming device 30 and the return request command for the self-device 20 to the return request standby part 43 through the signal line L1. Then, the return request standby part 43 gives the return request command for the image forming device 30 to the image forming device 30 through the signal line L3 and gives the return request command for the server device 20 to the server device 20 through the signal line L2. After that, in response to the return request command from the return request standby part 43, the devices 20 and 30 are changed from the power saving mode to the normal mode. After the server device 20 is returned to the normal mode, the server device 20 transmits the received job (herein, the printing job) to the image forming device 30, and after the image forming device 30 is returned to the normal mode, the image forming device 30 performs the received printing job.

Then, description will be back to the operation in the period T63 of FIG. 18 again.

In the case where both the server device 20 and the image forming device 30 are each in the power saving mode, the power supply control part 41 controls the supply of electric power to the operation display part 40 so that the output voltage from the power source of the power supply device should not be supplied to the touch panel 45 and the like of the operation display part 40 and the output voltage should be supplied to the return request standby part 43. Further, herein, as described above, the server device 20 has been determined as the power supply device.

Specifically, the power supply control part 41 controls the changeover switches SW31 and SW21 (see FIG. 26) so that the changeover switch SW31 should be in the closed state and the changeover switch SW21 should be in the open state. With this control, no electric power (voltage) is supplied from the power source 21 of the server device 20 which is determined as the power supply device to the touch panel 45 and the like of the operation display part 40, and the operation of the touch panel 45 and the like is stopped. On the other hand, the electric power (voltage) is continuously supplied from the power source 21 to the return request standby part 43 of the operation display part 40, and the operation of the return request standby part 43 continues. Further, the output voltage is supplied from the power supply device (herein, the server device 20) also to the power supply control part 41.

After that, in the case where both the server device 20 and the image forming device 30 are each in the power saving mode, for example, when the image forming device 30 receives the printing job, the return request standby part 43 of the operation display part 40 acquires the return request command from the image forming device 30. Then, the return request standby part 43 gives the return request command to the power source 31 of the image forming device 30, and in response to the return request command, the image forming device 30 is returned from the power saving mode to the normal mode. After that, the image forming device 30 transmits a normal mode change notification indicating that the self-device is changed from the power saving mode to the normal mode to the operation display part 40 (the power supply control part 41) and performs the received printing job.

When (only) the image forming device 30 is returned from the power saving mode to the normal mode (a period T64 of FIG. 18), the operation display part 40 (the power supply control part 41) determines the device (the image forming device 30) which is in the normal mode, out of the devices 20 and 30, as the power supply device.

Specifically, the power supply control part 41 determines, on the basis of the normal mode change notification from the image forming device 30, that the image forming device 30 is changed from the power saving mode to the normal mode, and performs control so that the whole operation display part 40 can receive the power supply from the image forming device 30. In more detail, the power supply control part 41 controls the changeover switches (see FIG. 27) so that the changeover switches SW12, SW22, and SW32 should be in the closed state and the changeover switches SW11, SW21, and SW31 should be in the open state. With this control, the electric power (voltage) is supplied from the power source 31 of the image forming device 30 which is in the normal mode to the whole operation display part 40, and the operation of the whole operation display part 40 is started (resumed).

Herein, if the device which is in the power saving mode intends to supply electric power to the operation display part 40, the device supplies electric power to the operation display part 40 after the self-device is returned from the power saving mode to the normal mode. In short, in order to supply electric power to the operation display part 40, the device which must be originally kept in the power saving mode is disadvantageously returned to the normal mode. As a result, it is not possible to ensure reduction in the power consumption (power saving) in the MFP 10.

On the other hand, in the fifth preferred embodiment, in the case where there are a device which is in the normal mode and another device which is in the power saving mode among the plurality of devices, the device which is in the normal mode is determined as the power supply device. For this reason, the electric power mode of the device which is in the power saving mode can be kept in the power saving mode. Therefore, it is possible to determine the power supply device in consideration of power saving in the MFP 10.

Further, in the case where there is no device which is in the normal mode among the plurality of devices, the supply of electric power to the operation display part 40 is controlled so that the output voltage from the power source of the power supply device should not be supplied to the touch panel 45 and the like of the operation display part 40 and the output voltage should be supplied to the return request standby part 43. In short, the output voltage from the power source of the power supply device is not supplied to the constituent part (the touch panel 45 and the like) which is not used and the output voltage is supplied to the constituent part (the return request standby part 43) which serves to return the device which in in the power saving mode to the normal mode. Therefore, it is possible to operate the operation display part 40 with requisite minimum electric power.

Furthermore, though the fifth preferred embodiment is exemplarily shown as a variation of the above-described first preferred embodiment herein, not being limited to the first preferred embodiment, the concept of the above-described fifth preferred embodiment may be applied to the other preferred embodiments and the like.

Further, though the return request standby part 43 acquires the return request command from the device in the above-described fifth preferred embodiment, the present invention is not limited to this exemplary case but the return request standby part 43 may acquire the return request command within itself by using various sensors or the like. Specifically, the return request standby part 43 may acquire (detect) an operation input to the operation member (the touch panel 45, and hardware buttons and the like which are arranged around the touch panel 45) provided in the operation display part 40, as the return request command Alternatively, the return request standby part 43 may acquire (detect) that the user is approaching to within a predetermined range from the MFP 10, by using a proximity sensor or the like, as the return request command

### 6. Variations, etc.

Though the preferred embodiments of the present invention have been described above, the present invention is not limited to the above-described exemplary cases.

Though the determination control of the power supply device and the like are performed by using the CPU 41a (see FIG. 21 and the like) in the above-described preferred embodiments and the like, for example, this is only one exemplary case and the determination control and the like may be performed without using the CPU 41a (only by using a hardware circuit).

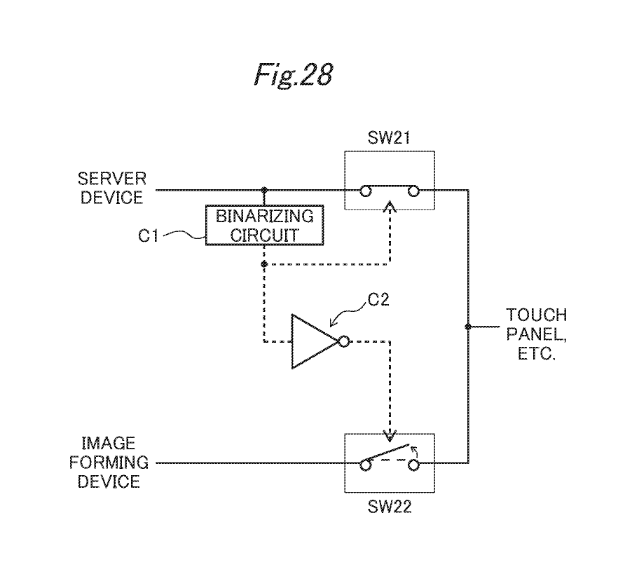

FIG. 28 is a control circuit diagram relating to determination control of the power supply device, and the like, in accordance with the modification.

In the control circuit diagram of FIG. 28, an electronic circuit (device selection circuit) including a binarizing circuit C1 and a logical NOT circuit C2 (also referred to as a NOT circuit) is provided.

The binarizing circuit C1 outputs a signal indicating a value of “1” or another value of “0” in accordance with whether the output voltage from the power source 21 of the server device 20 is larger than a predetermined reference value (for example, 4.5 V) or not, to the changeover switches SW21 and SW22. When the signal indicating the value of “1” is inputted, the changeover switches SW21 and SW22 are each brought into the closed state, and when the signal indicating the value of “0” is inputted, the changeover switches SW21 and SW22 are each brought into the open state.

The logical NOT circuit C2 is provided between the binarizing circuit C1 and the changeover switch SW22. The logical NOT circuit C2 inverts the signal outputted from the binarizing circuit C1 and outputs the inverted signal to the changeover switch SW22.

When the server device 20 is changed from the power-off state to the power-on state, for example, the power source 21 of the server device 20 applies an output voltage not lower than a predetermined value (for example, 5.0 V). On the basis that an output voltage not lower than the reference value (4.5 V) is applied by the power source 21, the binarizing circuit C1 outputs the signal indicating the value of “1” to the changeover switch SW21. Then, the signal indicating the value of “1” is inputted to the changeover switch SW21 without any change, and the changeover switch SW21 is brought into the closed state (see FIG. 28). On the other hand, the signal whose value is inverted by the logical NOT circuit C2 (the signal indicating the value of “0”) is inputted to the changeover switch SW22, and the changeover switch SW22 is brought into the open state (see FIG. 28).

With this operation, the output voltage from the power source 21 of the server device 20 is supplied to the operation display part 40 (the touch panel 45 and the like), and the operation display part 40 is operated by receiving the supply of electric power from the server device 20. In other words, when the server device 20 is in the power-on state, the changeover switches are controlled so that only the changeover switch SW21 should be in the closed state, regardless of the power supply state of the image forming device 30, and the server device 20 is determined as the power supply device. Then, the operation display part 40 is operated by receiving the power supply from the server device 20.

After that, in the case where the server device 20 is changed from the power-on state to the power-off state, for example, the binarizing circuit C1 outputs the signal indicating the value of “0” to the changeover switch SW21 on the basis that the output voltage from the power source 21 becomes lower than the reference value. Then, the signal indicating the value of “0” is inputted to the changeover switch SW21, and the changeover switch SW21 is changed into the open state. On the other hand, the signal whose value is inverted by the logical NOT circuit C2 (the signal indicating the value of “1”) is inputted to the changeover switch SW22, and the changeover switch SW22 is changed into the closed state. Then, in the case where only the image forming device 30 is in the power-on state, the output voltage from the power source 31 of the image forming device 30 is supplied to the operation display part 40 (the touch panel 45 and the like), and the operation display part 40 is operated by receiving the supply of electric power from the image forming device 300.

Thus, the determination control of the power supply device and the like may be performed without using the CPU 41a (only by using the hardware circuit). Further, the operations in the other preferred embodiments and the like may be similarly performed without using the CPU 41a (only by using the hardware circuit).

Further, though the MFP 10 is exemplarily shown as the information processing apparatus in the above-described preferred embodiments and the like, this is only one exemplary case and a personal computer, for example, may be used as the information processing apparatus.

Furthermore, though the server device 20 and the image forming device 30 are exemplarily shown as the plurality of devices provided in the information processing apparatus in the above-described preferred embodiments and the like, this is only one exemplary case. For example, the server device 20 and a client device (device capable of performing a function of a client computer) (not shown) may be provided in the information processing apparatus as the plurality of devices.

Moreover, though two devices are provided in the information processing apparatus in the above-described preferred embodiments and the like, this is only one exemplary case and three or more devices may be provided in the information processing apparatus.

Although embodiments of the present invention have been described and illustrated in detail, the disclosed embodiments are made for purposes of illustration and example only and not limitation. The scope of the present invention should be interpreted by terms of the appended claims.

What is claimed is:

1. An information processing apparatus comprising:
a plurality of devices each having a power source; and
a display which is shared by said plurality of devices and operated by receiving power supply from said power source of any one of said plurality of devices,
wherein said display has
a hardware processor which determines a power supply device out of said plurality of devices, on the basis of a state of each of said plurality of devices, said power supply device being a device which supplies electric power to said display from said power source thereof.

2. The information processing apparatus according to claim 1, wherein
said hardware processor determines said power supply device on the basis of whether each of said plurality of devices is in a power-on state or a power-off state.

3. The information processing apparatus according to claim 2, wherein
in a case where at least two devices among said plurality of devices are each in said power-on state, said hardware processor determines a device whose power source has the highest output voltage, out of said at least two devices, as said power supply device.

4. The information processing apparatus according to claim 3, wherein
said hardware processor acquires an output voltage of said power source of each of said at least two devices immediately after said output voltage from said power source of a device which is changed last into said power-on state, out of said at least two devices, is applied to said display and determines a device whose power source has the highest output voltage, out of said at least two devices, as said power supply device.

5. The information processing apparatus according to claim 3, wherein
said hardware processor regularly acquires an output voltage of said power source of each of said at least two devices and determines a device whose power source has the highest latest output voltage, out of said at least two devices, as said power supply device.

6. The information processing apparatus according to claim 2, wherein
any one of said plurality of devices is a device having a possibility of being changed from a first electric power mode to a second electric power mode which operates with a power consumption lower than a power consumption used in said first electric power mode,
said device which is capable of performing a mode change between said first electric power mode and said second electric power mode can be changed from said first electric power mode to said second electric power mode on the condition that no electric power is supplied to said display from said power source of said device,
said display is capable of performing a display processing relating to a device which is alternatively selected out of said plurality of devices, and
in a case where at least two devices among said plurality of devices are each in said power-on state, said hardware processor specifies a currently-displaying device which is a device performing display output on said display, out of said at least two devices, and
said hardware processor specifies said currently-displaying device as a device which has the lowest possibility of being changed to said second electric power mode, out of said at least two devices, and determines said currently-displaying device as said power supply device.

7. The information processing apparatus according to claim 6, wherein
even in a case where a display processing relating to said currently-displaying device is performed on said display, when one device different from said currently-displaying device performs a predetermined operation, said hardware processor specifies said one device, instead of said currently-displaying device, as said device which has the lowest possibility of being changed to said second electric power mode, out of said at least two devices, and determines said one device as said power supply device.

8. The information processing apparatus according to claim 7, wherein
said display is capable of receiving an operation input of a user, and
when a display processing relating to said currently-displaying device is performed on said display, said hardware processor determines said currently-displaying device as said power supply device within a period while it is determined that said operation input is performed to said display, regardless of whether said one device performs said predetermined operation or not.

9. The information processing apparatus according to claim 2, wherein
any one of said plurality of devices is a device having a possibility of being changed from a first electric power mode to a second electric power mode which operates with a power consumption lower than a power consumption used in said first electric power mode,
said device which is capable of performing a mode change between said first electric power mode and said second electric power mode can be changed from said first electric power mode to said second electric power mode on the condition that no electric power is supplied to said display from said power source of said device, and
in a case where at least two devices among said plurality of devices are each in said power-on state,
said hardware processor specifies a currently-predetermined operating device which is a device performing a predetermined operation, out of said at least two devices, and
said hardware processor specifies said currently-predetermined operating device as a device which has the lowest possibility of being changed to said second electric power mode, out of said at least two devices, and determines said currently-predetermined operating device as said power supply device.

10. The information processing apparatus according to claim 2, wherein
in a case where at least two devices among said plurality of devices are each in said power-on state, on the basis of respective priorities of said plurality of devices which are determined in advance,
said hardware processor determines a device which is determined to have the highest priority, out of said at least two devices, as said power supply device.

11. The information processing apparatus according to claim 2, wherein
said plurality of devices include a server device which is a device capable of performing a server function, and
in a case where at least two devices among said plurality of devices are each in said power-on state, when said server device is in said power-on state,
said hardware processor determines said server device as said power supply device.

12. The information processing apparatus according to claim 2, wherein
said plurality of devices include a predetermined device which is capable of performing a job consuming electric power not lower than a predetermined degree, and
in a case where at least two devices among said plurality of devices are each in said power-on state, when said predetermined device is performing said job,
said hardware processor determines a device other than said predetermined device, out of said at least two devices, as said power supply device.

13. The information processing apparatus according to claim 12, wherein
said job is a printing job for printing out an image, and
in a case where at least two devices among said plurality of devices are each in said power-on state, when said predetermined device is performing said printing job,
said hardware processor determines a device other than said predetermined device, out of said at least two devices, as said power supply device.

14. The information processing apparatus according to claim 12, wherein
said job is an image reading job for reading an original manuscript placed on a predetermined position, and
in a case where at least two devices among said plurality of devices are each in said power-on state, when said predetermined device is performing said image reading job,
said hardware processor determines a device other than said predetermined device, out of said at least two devices, as said power supply device.

15. The information processing apparatus according to claim 2, wherein
said plurality of devices include a predetermined device which is capable of performing a job consuming electric power not lower than a predetermined degree, and
said predetermined device is capable of detecting a preparing operation which is performed prior to execution of said job and performed for an operation member included in said predetermined device, and
in a case where at least two devices among said plurality of devices are each in said power-on state, when said preparing operation is detected in said predetermined device,
said hardware processor determines a device other than said predetermined device, out of said at least two devices, as said power supply device.

16. The information processing apparatus according to claim 2, wherein
said plurality of devices include a predetermined device which performs an initialization process consuming electric power not lower than a predetermined degree, at the startup of said predetermined device, and
in a case where at least two devices among said plurality of devices are each in said power-on state, when said predetermined device is performing a startup process including said initialization process,
said hardware processor determines a device other than said predetermined device, out of said at least two devices, as said power supply device.

17. The information processing apparatus according to claim 1, wherein
each of said plurality of devices is capable of being changed from a first electric power mode to a second electric power mode which operates with a power consumption lower than a power consumption used in said first electric power mode, and
said hardware processor determines said power supply device on the basis of whether each of said plurality of devices is in said first electric power mode or said second electric power mode.

18. The information processing apparatus according to claim 17, wherein
in a case where at least two devices among said plurality of devices are each in said first electric power mode,
said hardware processor determines a device whose power source has the highest output voltage, out of said at least two devices, as said power supply device.

19. The information processing apparatus according to claim 18, wherein
said hardware processor acquires an output voltage of said power source of each of said at least two devices immediately after said output voltage from said power source of a device which is changed last into said first electric power mode, out of said at least two devices, is applied to said display and determines a device whose power source has the highest output voltage, out of said at least two devices, as said power supply device.

20. The information processing apparatus according to claim 18, wherein
said hardware processor regularly acquires an output voltage of said power source of each of said at least two devices and determines a device whose power source has the highest latest output voltage, out of said at least two devices, as said power supply device.

21. The information processing apparatus according to claim 17, wherein
each of said plurality of devices is capable of being changed from said first electric power mode to said second electric power mode on the condition that no electric power is supplied to said display from said power source thereof,
said display is capable of performing a display processing relating to a device which is alternatively selected out of said plurality of devices, and
in a case where at least two devices among said plurality of devices are each in said first electric power mode,
said hardware processor specifies a currently-displaying device which is a device performing display output on said display, out of said at least two devices, and
said hardware processor specifies said currently-displaying device as a device which has the lowest possibility of being changed to said second electric power mode, out of said at least two devices, and determines said currently-displaying device as said power supply device.

22. The information processing apparatus according to claim 21, wherein
even in a case where a display processing relating to said currently-displaying device is performed on said display, when one device different from said currently-displaying device performs a predetermined operation, said hardware processor specifies said one device, instead of said currently-displaying device, as said device which has the lowest possibility of being changed to said second electric power mode, out of said at least two devices, and determines said one device as said power supply device.

23. The information processing apparatus according to claim 22, wherein
said display is capable of receiving an operation input of a user, and
when a display processing relating to said currently-displaying device is performed on said display, said hardware processor determines said currently-displaying device as said power supply device within a period while it is determined that said operation input is performed to said display, regardless of whether said one device performs said predetermined operation or not.

24. The information processing apparatus according to claim 17, wherein
each of said plurality of devices is capable of being changed from said first electric power mode to said second electric power mode on the condition that no electric power is supplied to said display from said power source thereof,
in a case where at least two devices among said plurality of devices are each in said first electric power mode,
said hardware processor specifies a currently-predetermined operating device which is a device performing a predetermined operation, out of said at least two devices, and
said hardware processor specifies said currently-predetermined operating device as a device which has the lowest possibility of being changed to said second electric power mode, out of said at least two devices, and determines said currently-predetermined operating device as said power supply device.

25. The information processing apparatus according to claim 17, wherein
in a case where at least two devices among said plurality of devices are each in said first electric power mode, on the basis of respective priorities of said plurality of devices which are determined in advance,
said hardware processor determines a device which is determined to have the highest priority, out of said at least two devices, as said power supply device.

26. The information processing apparatus according to claim 17, wherein
said plurality of devices include a server device which is a device capable of performing a server function, and
in a case where at least two devices among said plurality of devices are each in said first electric power mode, when said server device is in said first electric power mode,
said hardware processor determines said server device as said power supply device.

27. The information processing apparatus according to claim 17, wherein
said plurality of devices include a predetermined device which is capable of performing a job consuming electric power not lower than a predetermined degree, and
in a case where at least two devices among said plurality of devices are each in said first electric power mode, when said predetermined device is performing said job,
said hardware processor determines a device other than said predetermined device, out of said at least two devices, as said power supply device.

28. The information processing apparatus according to claim 27, wherein
said job is a printing job for printing out an image, and
in a case where at least two devices among said plurality of devices are each in said first electric power mode, when said predetermined device is performing said printing job,
said hardware processor determines a device other than said predetermined device, out of said at least two devices, as said power supply device.

29. The information processing apparatus according to claim 27, wherein
said job is an image reading job for reading an original manuscript placed on a predetermined position, and
in a case where at least two devices among said plurality of devices are each in said first electric power mode, when said predetermined device is performing said image reading job,
said hardware processor determines a device other than said predetermined device, out of said at least two devices, as said power supply device.

30. The information processing apparatus according to claim 17, wherein
said plurality of devices include a predetermined device which is capable of performing a job consuming electric power not lower than a predetermined degree, and
said predetermined device is capable of detecting a preparing operation which is performed prior to execution of said job and performed for an operation member included in said predetermined device, and
in a case where at least two devices among said plurality of devices are each in said first electric power mode, when said preparing operation is detected in said predetermined device,
said hardware processor determines a device other than said predetermined device, out of said at least two devices, as said power supply device.

31. The information processing apparatus according to claim 17, wherein
said plurality of devices include a predetermined device which performs an initialization process consuming electric power not lower than a predetermined degree, at the startup of said device, and
in a case where at least two devices among said plurality of devices are each in said first electric power mode, when said predetermined device is performing a startup process including said initialization process,
said hardware processor determines a device other than said predetermined device, out of said at least two devices, as said power supply device.

32. The information processing apparatus according to claim 17, wherein
each of said plurality of devices is capable of supplying electric power to said display on the condition that said each device is in said first electric power mode, and
in a case where there are a device which is in said first electric power mode and another device which is in said second electric power mode among said plurality of devices, said hardware processor determines said device which is in said first electric power mode, as said power supply device.

33. The information processing apparatus according to claim 17, wherein
said hardware processor is a first hardware processor,
said display further has:
a display panel capable of displaying various information; and
a second hardware processor capable of waiting a return request command indicating that said device which is in said second electric power mode should be returned to said first electric power mode, and
in a case where there is no device which is in said first electric power mode among said plurality of devices,
said first hardware processor determines one device which is in said second electric power mode, as said power supply device, and
said first hardware processor controls supply of electric power to said display so that an output voltage from said power source of said one device should not be supplied to said display panel and said output voltage should be supplied to said second hardware processor.

34. The information processing apparatus according to claim 1, wherein
said plurality of devices are accommodated in one package.

35. A non-transitory computer-readable recording medium for recording therein a computer program to be executed by a computer provided in a display which is provided in an information processing apparatus comprising a plurality of devices each having a power source and is shared by said plurality of devices, to cause said computer to perform:
a) acquiring a state of each of said plurality of devices; and
b) determining a power supply device which is a device that supplies electric power to said display from said power source thereof, out of said plurality of devices, on the basis of said state acquired in said operation a), said display being operated by receiving power supply from said power source of any one of said plurality of devices.

36. An information processing apparatus comprising:
a plurality of devices each having a power source; and
a display which is shared by said plurality of devices and operated by receiving power supply from said power source of any one of said plurality of devices,
wherein said display has
an electronic circuit which determines a power supply device out of said plurality of devices, on the basis of a state of each of said plurality of devices, said power supply device being a device which supplies electric power to said display from said power source thereof.
